(19) United States
(12) Patent Application Publication
(10) Pub. No.: US 2017/0236158 A1
(43) Pub. Date: Aug. 17, 2017

(54) System and methods for creating and using consumer sponsorships

(71) Applicants: GRANT HENDERSON, Las Vegas, NV (US); SARAH GRAY, Las Vegas, NV (US)

(72) Inventors: GRANT HENDERSON, Las Vegas, NV (US); SARAH GRAY, Las Vegas, NV (US)

(21) Appl. No.: 15/043,585

(22) Filed: Feb. 14, 2016

(51) Int. Cl. G06Q 30/02

(52) U.S. Cl. CPC G06Q 30/0257; G06Q 30/0277

(57) ABSTRACT

A computerized system and methods that create and use consumer sponsorships.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD

The present invention relates to the fields of business management, economics, computer science, information science, software engineering, and generally to a database of records compiled from data entities with common links and methods that transform these records.

### BACKGROUND

Currently, businesses predominantly use two methods of reaching consumers: commercial sponsorships and advertising.

Under a commercial sponsorship, a business associates its product or brand with a third-party brand in order to reach the audience of that third-party brand. For example, a business contracts with a pop music artist to feature the business's logo, jingle, product, slogan, and/or promotional material in conjunction with the artist's music, concert, CD, and/or personal appearance. The business associates with the artist in hopes that the members of that artist's audience will notice the business's product or brand and will extend the goodwill felt towards the artist to the business.

Under an advertising technique, a business creates a presentation promoting the business's products and/or services. The business then arranges to have that presentation delivered to consumers through print, broadcast, mailing, internet, and/or other media. For example, a business creates a 60-second audio/visual commercial and arranges to have that commercial broadcast on television during a sporting event. On the internet, such advertisements are often presented as a precondition for the user's viewing of a particular piece of media content (such as a 15-second commercial that plays prior to the desired video), or as a prominent feature of the viewing screen during the consumer's viewing of that media content (such as a banner advertisement that stays at the top of the screen while the video plays below).

These methods are inefficient and undesirable for many reasons.

From the consumer's standpoint, most advertising is intrusive, coercive, and poorly targeted. Ads for specific items the consumer has previously searched for or viewed online (“stalker ads”) often fail to match the consumer's current preferences (“I searched for shoes—but now I've purchased shoes, and they still constantly show me shoe ads.”) or seem invasive of the consumer's privacy. Less intrusive “blanket” ads, which are presented to all consumers in a particular location without regard to the interest level of any particular consumer, frequently result in consumers' receiving ads in which they have no interest. “Profile” ads, foisted upon the consumer based on that consumer's demographics and internet activity, are both intrusive to the consumer's privacy and poorly targeted to the individual's specific tastes (e.g., ads for a local pizza shop may be displayed to a consumer based on the consumer's age, location, and status as a college student—without regard to the fact that the particular consumer is vegan and never eats pizza).

Both advertising and commercial sponsorships are enormously inefficient, as only a portion of the audience will be exposed to the presentation, a smaller portion will actually notice the presentation, and an even smaller portion will act on the presentation. In addition, advertising also risks alienating the consumers the business hopes to attract by forcing the advertisement on them. The significant rise in the use of ad-blocking technology demonstrates consumers' growing dissatisfaction with current advertising models.

Advertising a product or service with particular content may result in a negative association with a brand if the desired consumer views the accompanying content negatively (e.g., a wholesome family brand's ad accompanies violent content). A commercial sponsorship similarly risks a negative backlash if the third-party entity subsequently behaves in a way that generates negative publicity. For example, a commercial sponsorship linking a brand to a pop music artist may alienate consumers from the brand if that artist is arrested for drunk driving or for spousal abuse.

Both commercial sponsorships and advertisements are indirect methods of reaching consumers that employ shotgun approaches, whereby the business puts its materials in front of a large audience in hopes of attracting a small percentage of that audience. In neither case does the business directly connect (or seek to directly connect) with an individual consumer.

Both methods also are difficult to measure and evaluate. Without substantial follow-up work, a business cannot know whether any particular consumer was brought in by any particular advertisement or commercial sponsorship. Even if a rise in overall business follows the implementation of a campaign, so many other factors (including the overall economy) can affect such trends that a cause-and-effect relationship is difficult or impossible to identify. Basically, each business simply throws money at various types of advertisements and sponsorships and hopes that increased business follows.

Finally, both methods are poorly suited to maintaining ongoing brand awareness or executing detailed, multi-part campaigns. For example, a brand that wants a target consumer to see its brand at least once a month cannot typically achieve that goal through commercial sponsorships or advertisements.

All of these problems exist because businesses use indirect methods to try to communicate with consumers, leading to inefficiency, inaccuracy, and measurability problems while also potentially alienating the very consumers the businesses hope to reach.

The indirect methods of commercial sponsorships and advertising negatively impact both businesses and consumers.

### SUMMARY OF THE INVENTION

The present invention teaches a system and methods for creating and using a Consumer Sponsorship—a direct connection between a business and a consumer, each of which has explicitly chosen to connect with the other. The phrase “Sponsorship System” is used as a simplified reference to this invention.

The ideal embodiment accomplishes this by enabling a business to designate characteristics of its desired consumer audience and then invite consumers with those characteristics to select the business for a Consumer Sponsorship. The Sponsorship System creates a direct relationship between the business (or “sponsor”) and consumer. Unlike commercial sponsorships, in which the sponsoring business is linked to the sponsored entity (e.g., the soft drink company is linked to a sports team), and unlike advertising, in which the business's ads are linked to the content (e.g., the ads display statically on a blog or the ads display based on search phrases), the Consumer Sponsorship links the sponsor directly to the consumer at the consumer's request. Linking the consumer directly to the sponsor eliminates the vast majority of inefficiencies, inaccuracies, and guesswork involved in commercial sponsorships and advertising.

Whereas commercial sponsorships and advertisements negatively impact both businesses and consumers, the present invention directly serves the preferences and interests of both.

The system comprises:

a central database system that stores information about the state of each data entity and the relationships between data entities, including communications and transactions;

methods for storing and transforming information involving data entity relationships, communications, and transactions; and

computer servers (including but not limited to server farms and other scalable server technologies) and physical network connections (including but not limited to ethernet, wi-fi, and other electronic data networks) that facilitate electronic communication from the Sponsorship System to any remote terminal (including but not limited to a computer, mobile device, tablet, or other input/output device).

### BRIEF DESCRIPTION OF THE DRAWINGS

FIG. 1 illustrates a computer system architecture, including the Sponsorship System, its servers, databases, methods, a computer network, and the remote terminal of a Participant.

FIG. 2 illustrates an entity relationship diagram of database tables.

FIG. 3 illustrates a set of database tables.

FIG. 4 illustrates a computerized method for creating a Consumer Sponsorship.

FIG. 5 illustrates a computerized method for creating a Consumer Sponsorship at a point of sale.

FIG. 6 illustrates a computerized method for creating a Consumer Sponsorship via code redemption.

FIG. 7 illustrates a computerized method for creating multiple Consumer Sponsorships.

FIG. 8 illustrates a computerized method for creating Consumer Sponsorships during creation of a Campaign.

FIG. 9 illustrates a computerized method for using one or more Consumer Sponsorships.

FIG. 10 illustrates a computerized method for using a single Consumer Sponsorship.

### DETAILED DESCRIPTION OF THE INVENTION

The present invention teaches a system and methods for creating and using Consumer Sponsorships. The phrase “Sponsorship System” is used as a simplified reference to this invention.

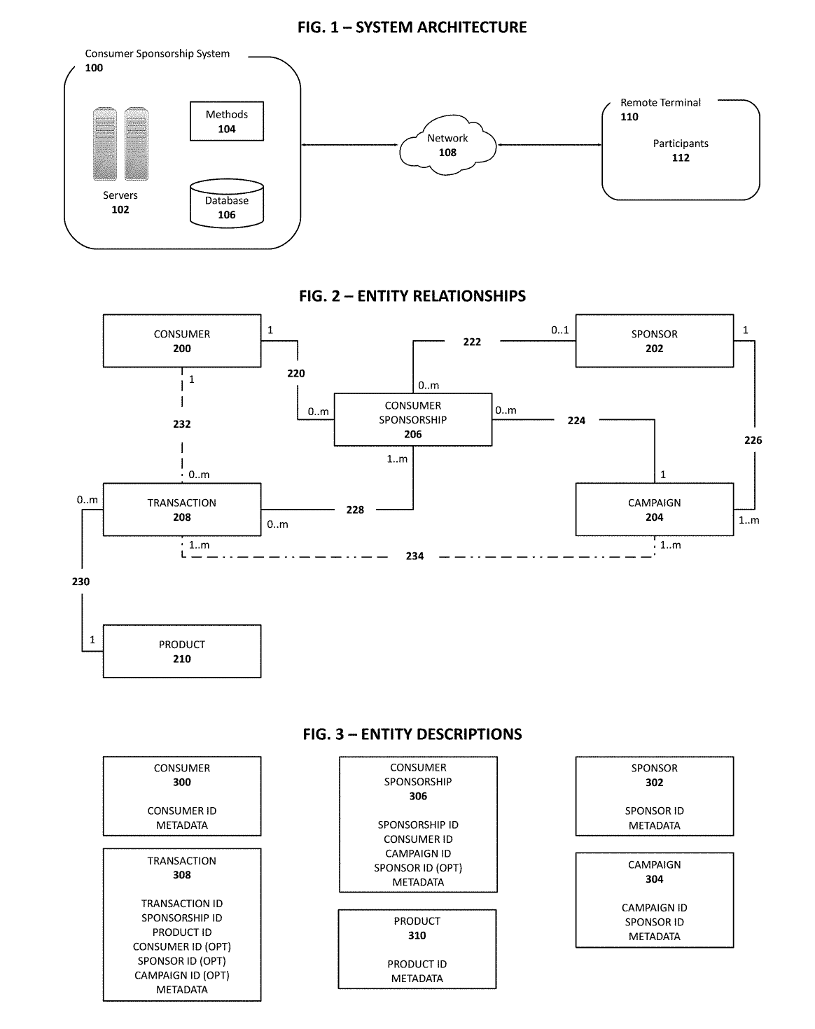

A block diagram of the Sponsorship System is shown in FIG. 1.

The Sponsorship System 100 comprises:

a database system 106 that stores information about each data entity and about the relationships between entities;

computerized methods 104 for storing and manipulating information involving data entity relationships;

computer servers 102 (including, but not limited to, server farms, distributed computers, and/or other scalable server technologies) and physical network connections 108 (including, but not limited to, ethernet, wi-fi, and/or other electronic data networks) that facilitate electronic communication from the Sponsorship System 100 to any remote terminal 110 (including, but not limited to, personal computers, server computers, mobile devices, tablets, and/or other input/output devices).

The computerized methods 104 are executed by one or more data processors using processor memory within the computer servers 102 of the Sponsorship System 100 that manipulate data stored in the database 106 according to the rules of the computerized method.

The computerized methods 104 of the Sponsorship System 100 are accessed and initiated via HyperText Markup Language (HTML), application programming interfaces (API), and/or other network and communications technologies at a Remote Terminal 110 by one or more Participants 112. A Participant interacting with the system may be a Consumer, Sponsor, or a computerized agent of either.

### Definitions

The following definitions clarify terminology.

A Consumer Sponsorship (“Sponsorship” or “Account”) is any arrangement in which Value is provided by a Sponsor to a Consumer.

A Participant is a Sponsor or a Consumer.

A Sponsor is any individual or entity (or agent thereof) that is willing to provide Value to a Consumer. Common examples of Sponsors include corporations, non-profit organizations, educational institutions, and individuals.

A Consumer is any individual or entity (or agent thereof) to whom Value may be provided. A Consumer will commonly be an individual, but may be an entity. For example, a business that sells Products to other businesses may wish to offer a Sponsorship to one of those businesses, which would then be a Consumer. In this case, the same Participant may be both a Sponsor and a Consumer under different Sponsorships (e.g., a retailer is a Sponsor of its Consumers, but a Consumer under a Sponsorship from one of its suppliers). A Sponsorship given to an entity may, but need not, be further distributed to individuals associated with that entity (e.g., a corporation receives a Sponsorship from one of its suppliers, and distributes the Sponsorship to the individual employees who deal with that supplier).

Value is any benefit(s), tangible and/or intangible, given and/or received as part of, or as a result of, a Sponsorship. The most common form of Value is money, and this disclosure primarily refers to Value as money in order to illustrate the invention, but other forms of Value are possible (e.g., in a points system, points may be used rather than money to represent Value).

Original Balance is an Attribute of a Sponsorship record equal to the amount of Value assigned to the Sponsorship at its inception.

Balance is an Attribute of a Sponsorship at any time equal to the remaining amount of Value assigned to the Sponsorship, consisting of the Original Balance, plus any additional amounts of Value assigned to the Sponsorship after its inception, minus all amounts of Value previously used by the Consumer.

Consumer Identification is any information that uniquely identifies a Consumer (e.g., email address, telephone number, credit card number, fingerprint, or Social Security Number).

A Campaign is a set of parameters defined by a Sponsor under which Sponsorship Offers may potentially be presented to Consumers for selection, and under which Sponsorships may be created. For example, a Sponsor may create a Campaign under which the Sponsor offers Sponsorships to Consumers between the ages of 18 and 25 who live in California. A Campaign may also include parameters governing the use of Sponsorships created under that Campaign. For example, a Sponsor may limit the use of Sponsorships created under a Campaign to a certain time (e.g., those Sponsorships may be used only between the hours of 9 am and 5 pm) or to a certain location (e.g., the Sponsorships may be used only when the Consumer is located in California at the time of use). The parameters of a Campaign are stored as Attributes of that Campaign record. One of ordinary skill in the art will recognize many variations and combinations of parameters that a Sponsor could designate for a Campaign.

A Sponsorship Offer is a potential Sponsorship that is available for presentation to, and selection by, a Consumer. The Campaign determines whether a Sponsorship Offer may be presented to a Consumer for selection. For example, a Sponsor may create a Campaign under which Sponsorship Offers may be presented only to Consumers between the ages of 18 and 25 and who live in California. A Sponsorship Offer is transient until selected by the Consumer, at which time the Sponsorship Offer becomes a Sponsorship.

A Product is any good or service. For example, a Product may be, without limitation, a movie, a book, a news article, a blog post, a lecture, educational material, an electronic file, a process, or a music video. A Product may also be a service or feature desired by the Consumer. For example, a Product may be, without limitation, cloud-hosting or specialized presentation or customization of user interface features.

Media is a type of Product that includes sound, words, still images, and/or video that often also includes intangible qualities such as intellectual property.

Price is an Attribute of a Product record that reflects the cost of the Product. Price is typically expressed in any form of currency. For example, the Price for a Consumer to view a particular music video may be $0.03. However, Price may be expressed in other units (e.g., points under a points system).

A Transaction is the use of at least one Sponsorship in connection with the delivery of a Product to a Consumer.

An Interstitial Product is anything provided or selected by a Sponsor that may accompany the Consumer's use of a Sponsorship. Examples may include, without limitation, a commercial, a banner ad, a watermark on the Product (e.g., over a video), a survey question, or data collection (e.g., where the Interstitial Product is permission to record consumer behavior or access consumer data). The inclusion of an Interstitial Product in a Sponsorship is optional; the Sponsor may choose to offer a Sponsorship with no Interstitial Product. For example, a philanthropist who sponsors educational Products for children may elect not to provide any Interstitial Product. For another example, a Sponsor primarily interested in obtaining data about the Consumer (e.g., data about the Consumer's consumption of Products) may choose to include with its Sponsorship a background Interstitial Product that collects data.

Attributes include any information that may be used to describe an object and are stored as metadata with the object. Attributes may be included in any record. An Attribute typically has a name and a value. For example, an Attribute of a Consumer 200 record may have the name “Gender” and value “male,” signifying that that Consumer is male. For another example, one Attribute of a Sponsor 202 record may have the name “Gender” and value “male,” signifying that that Sponsor will allow Sponsorship Offers to be presented to only male Consumers. The value of an Attribute may be a single item, a list of items, or another Attribute. One of ordinary skill in the art will recognize how Attributes are intended to be used.

Consumer Attributes are the Attributes of a Consumer 200 record.

Sponsor Attributes are the Attributes of a Sponsor 202 record.

Campaign Attributes are the Attributes of a Campaign 204 record.

Sponsorship Attributes are the Attributes of a Sponsorship 206 record.

Transaction Attributes are the Attributes of a Transaction 208 record.

Product Attributes are the Attributes of a Product 210 record.

Matching is a process in which the processor compares two or more sets of metadata and determines whether the criteria of one set satisfy the criteria of one or more of the other set(s), by inclusion and/or exclusion. This process typically includes making comparisons of Attributes within the metadata, and one of ordinary skill in the art will be familiar with such techniques. No undue experimentation is required, as basic examples are sufficient to implement the present invention (e.g., Matching gender Attributes between Consumer 200, Sponsor 202, and Campaign 204 records).

A Match occurs when the processor engages in Matching and determines that the criteria of one set satisfy the criteria of one of the other set(s) being compared. For example, if a Campaign 204 record specifies that Sponsorship Offers may be presented to any female Consumer (i.e., the gender Attribute is female and there are zero other required Attributes) and the Consumer 200 record indicates that the Consumer is female (i.e., the gender Attribute is female), there is a Match between that Campaign 204 record and that Consumer 200 record. For another example, if a Sponsorship 206 record specifies that the Sponsorship may be used on any Product that is not R-rated (i.e., the rating Attribute excludes R-rated content and there are no other required Attributes) and the Product 210 record is rated G (i.e., the rating Attribute is G), there is a Match between that Sponsorship 206 record and that Product 210 record.

Ranking is a process in which the processor sorts objects according to specified criteria. For example, Sponsorship Offers may be Ranked according to their Original Balance, such that a Sponsorship Offer for $2.00 is Ranked over a Sponsorship Offer for $1.00. For another example, Sponsorship Offers may be Ranked according to the size of the Sponsor in order to give local brands an advantage over major brands (e.g., a local restaurant is Ranked over a car manufacturer).

Ranking may incorporate the preferences of Sponsors, Consumers, and/or the implementer of the Sponsorship System. For example, a Sponsor may prefer that its Sponsorship be used on educational Products, though it permits the Sponsorship to be used on other types of Products. In that case, the Sponsor's preference may be considered during the Ranking in connection with an educational Product to give it a higher position than it would receive based on other criteria. For another example, a Consumer may prefer being sponsored by local Sponsors. In that case, the Consumer's preference may result in a local Sponsor being Ranked over a non-local Sponsor, even though according to other criteria the non-local Sponsor would be Ranked more highly. For another example, the Sponsorship System may prefer Sponsorships with certain types of Interstitial Products, and may give even greater preference to Sponsorships that include no Interstitial Products.

These examples of Matching and Ranking, and all examples provided throughout the description, are illustrative and are in no way limiting. One of ordinary skill in the art will recognize any number of methods and/or criteria to Match and/or Rank records. These definitions are intended to act as a guide that allows flexibility for the implementer.

A Uniquely Structured Document is an electronic document created during the use of a Sponsorship that includes data according to a schema. In some cases, the schema is included with the document (e.g., XML) or the schema is standardized (e.g., HTML).

A Web Page is a type of Uniquely Structured Document that uses markup languages such as HTML, HTMLS, XHTML, WML, etc. to format the contents of the Uniquely Structured Document. One of ordinary skill in the art will be familiar with these and similar technologies.

A Data Contract is a type of Uniquely Structured Document used by application programming interface (API) requests and responses. Data Contracts may be text based (e.g., XML, JSON, JSV, CSV, or SOAP) and/or binary-coded (e.g., WCF packets over TCP/IP, or compressed CORBA). One of ordinary skill in the art will be familiar with these and similar technologies.

Entity Descriptions and Relationships

FIG. 3 illustrates one possible set of database tables and FIG. 2 illustrates an entity relationship diagram of the same tables that are used to store states and relationships in a database.

A Consumer 200 & 300 record includes a Consumer ID primary key field, and optionally metadata fields that describe other Attributes. Attributes of a Consumer 200 record may include, without limitation, data about the Consumer, such as age or gender, and/or contextual data, such as the time or location of Consumer activity. For example, if a Consumer creates or uses a Sponsorship while on an airplane, the contextual data regarding the Consumer's location (on an airplane) may be included in the Consumer 200 Attributes. The metadata fields are intended to be flexible to cover all possible Attributes. A Consumer 200 record may be hierarchical (e.g., multiple Consumer records under a family plan). A Consumer 200 record is used to identify and store the state of each Consumer.

A Sponsor 202 & 302 record includes a Sponsor ID primary key field, and optionally metadata fields that describe other Attributes. Attributes of a Sponsor 202 record may include, without limitation, data about the Sponsor, such as the location of the Sponsor, and/or limitations and/or conditions on Campaigns and/or Sponsorships that reference that Sponsor 202 record, such as a limitation that Sponsorship Offers may be presented only to female Consumers. The metadata fields are intended to be flexible to cover all possible Attributes. A Sponsor 202 record may be hierarchical (e.g., a parent corporation with franchises). A Sponsor 202 record is used to identify and store the state of each Sponsor.

A Campaign 204 & 304 record includes a Campaign ID primary key field, a Sponsor ID reference field to a Sponsor 202 record, and optionally metadata fields that describe other Attributes. Attributes of a Campaign 204 record may include, without limitation, data about the Campaign, such as the date the Campaign starts, and/or limitations and/or conditions on Sponsorships Offers that reference that Campaign 204 record, such as a limitation that Sponsorship Offers that reference that Campaign 204 record may be offered only to Consumers who live in California. Attributes of a Campaign 204 record may also include limitations or conditions on the use of Sponsorships that reference that Campaign 204 record, such as a condition that such Sponsorships not be used on Sundays. Optionally, a Campaign 204 record may inherit Attributes from the referenced Sponsor 202 record. For example, if a Sponsor 202 record includes an Attribute specifying that all Campaigns are restricted to the United States, then each Campaign 204 record that references that Sponsor 202 record may inherit that Attribute. The metadata fields are intended to be flexible to cover all possible Attributes. A Campaign 204 record may be hierarchical (e.g., a Campaign record for the United States encompassing multiple Campaign records for individual states). A Campaign 204 record is used to identify and store the state of each Campaign.

A Sponsorship 206 & 306 record includes a Sponsorship ID primary key field, a Consumer ID reference field to a Consumer 200 record, a Campaign ID reference field to a Campaign 204 record, and optionally metadata fields that describe other Attributes. Attributes of a Sponsorship 206 record may include, without limitation, data about the Sponsorship, such as the date on which it was last used, the Balance, or the Original Balance. Optionally, a Sponsorship 206 record may inherit Attributes from the referenced Campaign 204 record and/or from the Campaign 204 record's referenced Sponsor 202 record. For example, a Sponsorship record may inherit from the referenced Campaign record an Attribute that prevents that Sponsorship from being used on Sundays. Optionally, a Sponsorship 206 record may inherit Attributes from the referenced Consumer 200 record. For example, if the Consumer has a frequent flyer number with the Sponsor, the Sponsorship record may inherit that Attribute from the Consumer record. A Sponsorship 206 record may optionally include a Sponsor ID reference field to a Sponsor 202 record. The metadata fields are intended to be flexible to cover all possible Attributes. A Sponsorship 206 record may be hierarchical. A Sponsorship 206 record is used to identify and store the state of each Sponsorship.

A Sponsorship Offer is a transient Sponsorship 206 record containing no Consumer ID reference field because the Sponsorship has not yet been assigned to a Consumer. Optionally, the Sponsorship Offer 206 record may be stored permanently for auditing or statistical purposes (e.g., to track each Sponsorship Offer presented by each Sponsor to each Consumer). When a Sponsorship Offer is assigned to a Consumer, a permanent Sponsorship 206 record containing the Consumer ID reference field is created.

A Product 210 & 310 record includes a Product ID primary key field and optionally metadata fields that describe other Attributes. For example, one common Attribute of a Product 210 record may be the Price. A Product 210 record may be hierarchical (e.g., a playlist Product record references the Product records of each song on the playlist). The metadata fields are intended to be flexible to cover all possible Attributes. A Product 210 record is used to identify and store the state of each Product.

An Interstitial Product 210 record may be stored as a Product 210 record. The Attributes of an Interstitial Product 210 record may be limitations or conditions on its use. The Attributes of an Interstitial Product 210 record may also commonly include references to Sponsor 200, Campaign 204, and/or Sponsorship 206 records. For example, an Attribute on an Interstitial Product 210 record may specify that it may be used only on weekends, or only on the first use of the referenced Sponsorship 206 record.

A Transaction 208 & 308 record includes a Transaction ID primary key field, a Sponsorship ID reference field to a Sponsorship 206 record, a Product ID reference field to a Product 210 record, and optionally metadata fields that describe other Attributes. Attributes of a Transaction 208 record may include, without limitation, data about the Transaction, such as the date it was created, the Product 210 Price, and references to any Interstitial Product 210 record(s) that were delivered to the Consumer. A Transaction 208 record may also optionally include a Consumer ID reference field to a Consumer 200 record, a Sponsor ID reference field to a Sponsor 202 record, and/or a Campaign ID reference field to a Campaign 204 record. A Transaction record may be hierarchical (e.g., reference other Transaction 208 records like line items in an order, and therefore reference multiple Sponsorship 206 records). The metadata fields are intended to be flexible to cover all possible Attributes. A Transaction 208 record is used to identify and store the state of each Transaction.

Each Consumer 200 record references zero or more Sponsorship 206 records, and each Sponsorship 206 record references exactly one Consumer 200 record 220.

Each Sponsorship 206 record references exactly one Campaign 204 record, and each Campaign 204 record references zero or more Sponsorship 206 records 224.

Each Sponsorship 206 record may optionally reference exactly one Sponsor 202 record, and each Sponsor 202 record references zero or more Sponsorship 206 records 222.

Each Campaign 204 record references exactly one Sponsor 202 record, and each Sponsor 202 record references one or more Campaign 204 records 226.

If a Sponsorship 206 record references a Campaign 204 record but not a Sponsor 202 record, the Sponsor 202 record may be inferred via the referenced Campaign 204 record, as each Campaign 204 record references exactly one Sponsor 202 record 226.

Each Sponsorship 206 record references zero or more Transaction 208 records, and each Transaction 208 record references one or more Sponsorship 206 records 228.

Each Campaign 204 record may optionally reference one or more Transaction 208 records, and each Transaction 208 record may optionally reference one or more Campaign 204 records 234.

Each Transaction 208 record references exactly one Product 210 record, and each Product 210 record references zero or more Transaction 208 records 230.

Each Transaction 208 record may optionally reference one Consumer 200 record, and each Consumer 200 record may optionally reference zero or more Transaction 208 records 232.

If a Transaction 208 record does not directly reference a Consumer 200 record or a Campaign 204 record, both the Consumer 200 record and the Campaign 204 record may be inferred via the referenced Sponsorship 206 record, as each Sponsorship 206 record references exactly one Consumer 200 record and one Campaign 204 record.

Optionally, the Sponsor 202 record and Campaign 204 record may be combined into a single database record. For example, if a Sponsor has exactly one referenced Campaign, the Sponsor 202 record may encapsulate the Campaign 204 record including its keys and metadata.

Any record may inherit Attributes of any record that it references. For example, a Sponsorship 206 record may inherit Attributes from the referenced Campaign 204 record and/or the referenced Consumer 200 record; a Campaign 204 record may inherit Attributes from the referenced Sponsor 202 record. For another example, a Sponsorship 206 record may inherit from a Sponsor 202 record even if it does not directly reference the Sponsor 202 record (e.g., the Sponsorship 206 record references the Campaign 204 record, which inherits from the Sponsor 202 record).

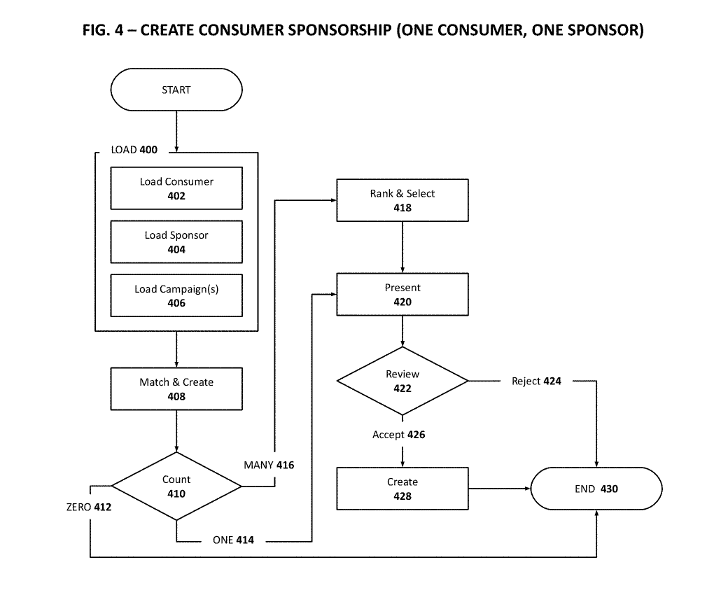

FIG. 4—Create Consumer Sponsorship (One Sponsor, One Consumer)

A Consumer initiates the process by requesting a Sponsorship from a specific Sponsor. For example, a Consumer may request and browse a presentation of potential Sponsors based on the Consumer's preferences (e.g., local businesses, specific products or services, new products, or a certain category of products) to identify a desired Sponsor, or may search for the name of a desired Sponsor. For another example, the Consumer may select a particular Sponsor through that Sponsor's website.

The processor loads 400 the Consumer 200 record 402, the Sponsor 202 record 404, and all Campaign 204 record(s) 406 that reference that Sponsor 202 record. The records may be loaded in sequence or in parallel, in any order.

The processor engages in Matching 408 the Consumer 200 Attributes with the Attributes of each Campaign 204 record (with each Campaign 204 record inheriting the Sponsor 202 Attributes) and creates 408 a transient set of Sponsorship Offer 206 records corresponding to each and every Match identified during that process.

For example, if the Campaign 204 record defines a location Attribute that is limited to New York and defines a gender Attribute (inherited from the Sponsor 202 record) that is limited to female Consumers, and the Consumer is a female in New York, the processor engages in Matching 408 to identify the Match and creates 408 a Sponsorship Offer 206 record that references that Campaign 204 record for inclusion in the set. If the Consumer is a male and/or not in New York, the processor will not identify a Match. One of ordinary skill in the art will recognize how more complex Matching may be performed.

The processor counts 410 the number of Sponsorship Offer 206 records in the set created during the Matching process 408.

If the set of Sponsorship Offer 206 records contains zero Sponsorship Offer 206 records 412, the process ends 430.

For example, if the Sponsor 202 Attributes limit the presentation of Sponsorship Offers to male Consumers, and the Consumer 200 Attributes indicate that the Consumer is female, the set contains zero Sponsorship Offer 206 records 412, and the process ends 430.

For another example, if the Sponsor 202 Attributes limit the presentation of Sponsorship Offer 206 records to male Consumers and the Campaign 204 Attributes of each Campaign 204 record that references that Sponsor 202 record require the Consumer's location to be in California, and the Consumer 200 Attributes indicate the Consumer is male and located in New York, there is no Match, the set contains zero Sponsorship Offer 206 records 412, and the process ends 430.

Alternatively, rather than ending the process 430, the processor may invite the Consumer to improve the Consumer 200 record in order to determine if the Consumer is eligible for other Campaigns (not illustrated).

If the set of Sponsorship Offer 206 records contains exactly one Sponsorship Offer 206 record 414, the processor presents 420 that Sponsorship Offer 206 record to the Consumer and the Consumer reviews 422 that Sponsorship Offer 206 record and either rejects 424 or accepts 426 it.

If the Consumer rejects 424 the Sponsorship Offer 206 record, the transient Sponsorship Offer 206 record is optionally discarded and the process ends 430.

Alternatively, rather than ending the process 430, the processor may invite the Consumer to improve the Consumer 200 record in order to determine if the Consumer is eligible for other Campaigns (not illustrated).

If the Consumer accepts 426 the Sponsorship Offer 206 record, the processor creates 428 a permanent Sponsorship 206 record that references both the Consumer 200 record and the Campaign 204 record, and optionally the Sponsor 202 record. The implementer may optionally include additional Attributes as metadata of the Sponsorship 206 record (e.g., the time of creation).

The transient Sponsorship Offer 206 record is optionally discarded, and the process ends 430.

If the set of Sponsorship Offer 206 records contains multiple Sponsorship Offer 206 records 416, the processor Ranks 418 the Sponsorship Offer 206 records in that set and selects 418 one or more of the Sponsorship Offer 206 records for presentation to the Consumer.

Obvious methods of Ranking 418 Sponsorship Offer 206 records for presentation to a Consumer include sorting by the date the referenced Campaigns were created, by Original Balances, or even randomly. One of ordinary skill in the art will recognize many methods of Ranking and selecting 418 Sponsorship Offer 206 records, each of which may incorporate the preferences of the Consumer, Sponsor, and/or the implementer.

In another embodiment, the processor may skip the Ranking 418 and present 420 all Sponsorship Offer 206 records in the set of Sponsorship Offer 206 records to the Consumer for selection. However, as a practical matter, it will often be desirable to limit the number of Sponsorship Offer 206 records presented to the Consumer so as to avoid overwhelming the Consumer (e.g., a large, multinational Sponsor may have twenty different Campaigns for which the Consumer is eligible, but presenting 420 the Consumer with twenty different Sponsorship Offer 206 records would generally be undesirable).

The processor selects 418 from the set of Sponsorship Offer 206 records and presents 420 to the Consumer one or more of the Sponsorship Offer 206 records. For example, the processor may select the top-Ranked Sponsorship Offer 206 record, or may select the top five Ranked Sponsorship Offer 206 records. One of ordinary skill in the art will recognize many methods for selecting 418 the Sponsorship Offer 206 record(s) for presentation to the Consumer, each of which may incorporate the preferences of the Consumer, Sponsor, and/or implementer.

For example, if the Consumer has a preference for a certain type of Interstitial Product (e.g., the Consumer prefers Interstitial Products that collect data as opposed to those that interrupt the Consumer's experience, such as videos), the processor may select 418 Sponsorship Offer 206 records that comport with the Consumer's preference.

The Consumer reviews 422 the presented Sponsorship Offer 206 record(s) and either rejects 424 all of them or accepts 426 one or more.

If the Consumer rejects 424 all of the presented Sponsorship Offer 206 record(s), the transient Sponsorship Offer 206 record(s) are optionally discarded and the process ends 430.

Alternatively, rather than ending the process 430, the processor may invite the Consumer to improve the Consumer 200 record in order to determine if the Consumer is eligible for other Campaigns (not illustrated).

If the Consumer accepts 426 one or more of the Sponsorship Offer 206 record(s), the processor creates 428 one or more Sponsorship 206 record(s) (e.g., one permanent Sponsorship 206 record for each Sponsorship Offer 206 record accepted) that reference both the Consumer 200 record and the Campaign 204 record (referenced by the accepted Sponsorship Offer 206 record), and optionally the Sponsor 202 record. The implementer may optionally include additional Attributes as metadata of the Sponsorship 206 record (e.g., an expiration date or the time of creation).

The transient Sponsorship Offer 206 records are optionally discarded, and the process ends 430.

Optionally, the presentation 420 of each Sponsorship Offer 206 record to the Consumer may include only identification of the Sponsor, or may include some or all details of the Sponsorship Offer. For example, the Sponsorship Offer may be presented with no details (e.g., “a Sponsorship from Acme Corp”), with a descriptive title but no details of the Sponsorship Offer (e.g., “a Gold Sponsorship from Acme Corp”), or with some details of the Sponsorship Offer (e.g., “a $2.00 Sponsorship from Acme Corp”). Omitting the Original Balance of the Sponsorship Offer 206 record may encourage Consumers to select Sponsors based on their interest in the Sponsor, rather than based on the Original Balance of the Sponsorship Offer. One of ordinary skill in the art will recognize many possible variations of presentation of Sponsorship Offers to the Consumer, and the processor may use any manner of presentation according to the preferences of the Sponsor and/or implementer.

Optionally, the processor may place conditions on the Consumer's acceptance of Sponsorship Offers (e.g., the Consumer may accept only one Sponsorship Offer) according to the preferences of the Sponsor and/or implementer.

While the process has been presented here in detail, one of ordinary skill in the art will recognize that the loading, Matching, Ranking, and other steps in this process may be done in many different combinations and/or sequences. For example, one could load 400 the Consumer 200 record, Sponsor 202 record, and Campaign 204 records, Match 408 Consumer 200 Attributes and the Attributes of each Campaign 204 record to create a set of Sponsorship Offer 206 records, count the records in the set, and Rank and select 418 Sponsorship Offer 206 records in a single step (e.g., using a complex SQL query).

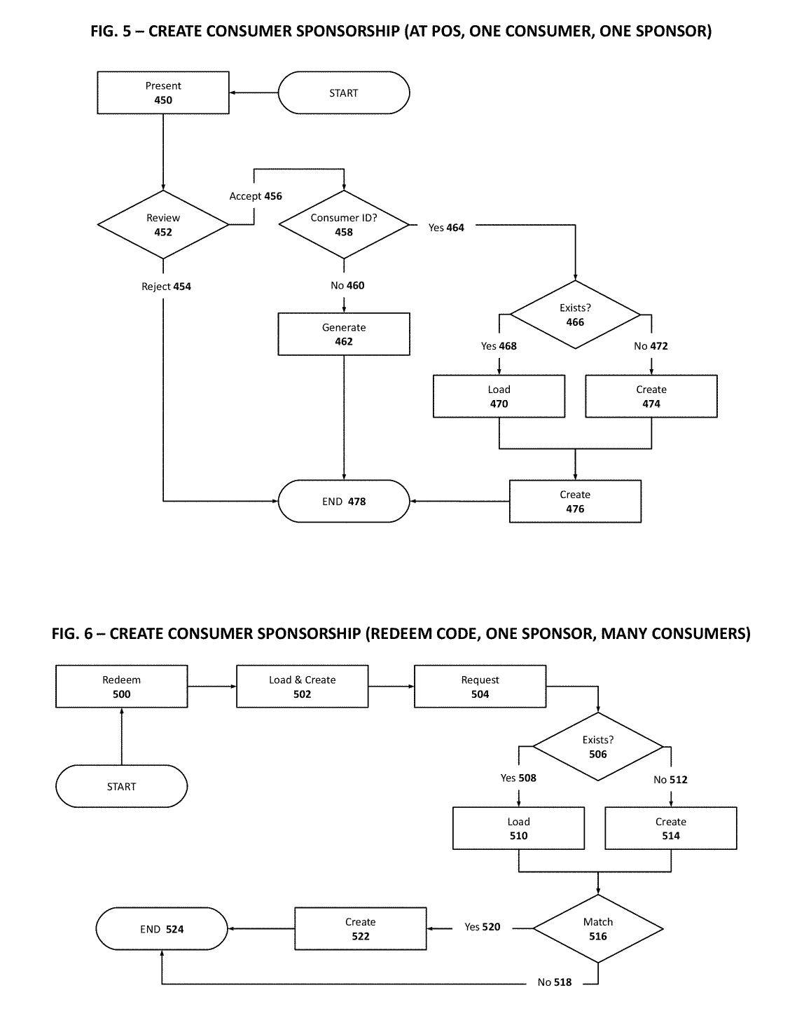

FIG. 5—Create Consumer Sponsorship (at Point of Sale, One Sponsor, One Consumer)

It may be desirable to create a Sponsorship at a point of sale, such as where the Sponsor wishes to give Sponsorships to existing customers. For example, a Sponsor may present Sponsorship Offers to a Consumer at the time the Consumer makes a purchase at the Sponsor's place of business.

The processor loads the Sponsor 202 record and the Campaign 204 record, and creates a transient Sponsorship Offer 206 record that references the Campaign 204 record (not illustrated). The records may be loaded in sequence or in parallel, in any order.

The processor presents 450 the Sponsorship Offer 206 record to the Consumer via a point of sale terminal.

Optionally, the processor may present 450 the Sponsorship Offer 206 record via a point of sale terminal to another person, who then presents the Sponsorship Offer to the Consumer. For example, a cashier may present the offer to a Consumer during the payment process at a brick-and-mortar store (e.g., “Would you like a Sponsorship from our business?”).

Optionally, the presentation of the Sponsorship Offer 206 record to the Consumer may include only identification of the Sponsor, or may include some or all details of the Sponsorship Offer. For example, the Sponsorship Offer may be presented with no details (e.g., “a Sponsorship from Acme Corp”), with a descriptive title but no details of the Sponsorship Offer (e.g., “a Gold Sponsorship from Acme Corp”), or with some details of the Sponsorship Offer (e.g., “a $2.00 Sponsorship from Acme Corp”). One of ordinary skill in the art will recognize many possible variations of presentation of Sponsorship Offers to the Consumer, and the processor may use any manner of presentation according to the preferences of the Sponsor and/or implementer.

If a Sponsor has multiple Campaign 204 records that yield multiple Sponsorship Offer 206 records at the point of sale, the processor may optionally Rank those Sponsorship Offer 206 records and select one or more Sponsorship Offer 206 record(s) for presentation to the Consumer (e.g., FIG. 4 418) For example, the processor may Rank the Sponsorship Offer 206 records by the end date of the referenced Campaign 204 record, Original Balance, or even randomly, and then select and present the top-Ranked Sponsorship Offer 206 record. One of ordinary skill in the art will recognize many other ways to Rank and select Campaigns. Optionally, the implementer may allow the Consumer to select one from multiple Sponsorship Offer 206 records presented, or may allow the Consumer to select multiple Sponsorship Offer 206 records.

The Consumer reviews 452 the Sponsorship Offer 206 record and either rejects 454 or accepts 456 it.

If the Consumer rejects 454 the Sponsorship Offer 206 record, the transient Sponsorship Offer 206 record is optionally discarded, and the process ends 478.

If the Consumer accepts 456 the Sponsorship Offer 206 record, the processor requests 458 Consumer Identification.

The processor may request 458 a specific type of Consumer Identification (e.g., an email address) or may request 458 that the Consumer provide any one of several specified types of Consumer Identification (e.g., an email address or a telephone number).

If the Consumer does not provide 460 Consumer Identification, the processor generates 462 a code that references the Campaign 204 record for the Consumer to use in later registration for the Sponsorship Offer 206 record, and the process ends 478.

Alternatively, the process may end 478 without the generation 462 of such a code (e.g., if a Sponsor permits Sponsorships to be created only at the point of sale in order to reduce the potential for fraud).

One of ordinary skill in the art will be familiar with methods of generating unique codes via algorithms or by creating a predefined list of codes to track Sponsors, Campaigns, and/or individual Consumers (e.g., sequential or random codes that can be tracked and redeemed). For example, sequential numbers with a checksum are commonly implemented. Any method of code generation may be used.

If the Consumer provides 464 a form of Consumer Identification, the processor determines 466 whether a Consumer 200 record containing that Consumer Identification exists.

If a Consumer 200 record containing the provided Consumer Identification exists 468, the processor loads 470 that Consumer 200 record.

If no Consumer 200 record containing the provided Consumer Identification exists 472, the processor creates 474 a Consumer 200 record containing the Consumer Identification.

Optionally, when creating 474 a Consumer 200 record, the processor may also request that the Consumer provide additional information in order to create the Consumer 200 record.

The processor creates 476 a Sponsorship 206 record that references both the Consumer 200 record and the Campaign 204 record, and optionally the Sponsor 202 record. The implementer may optionally include additional Attributes as metadata of the Sponsorship 206 record (e.g., an expiration date or the time of creation).

The transient Sponsorship Offer 206 record is optionally discarded, and the process ends 478.

FIG. 6—Create Consumer Sponsorship (Redeem Code, One Sponsor, Many Consumers)

Redemption of a unique code that is associated with a product provides a simple way to initiate a Sponsorship. The code will contain information that identifies the Campaign, and optionally the Sponsor. In some cases, the code may identify a unique product unit (e.g., code inside bottle cap, inside cereal box, or printed on receipt), or it may refer to any unit of a product (e.g., Universal Product Code).

A Consumer initiates the process and redeems 500 a code. For example, the Consumer may enter into a web page a unique code printed on the receipt from a prior purchase, or may scan a QR code using a mobile device.

The processor loads 502 the referenced Campaign 204 record (and optionally the Sponsor 202 record) and creates 502 a Sponsorship Offer 206 record that references the Campaign 204 record. The records may be loaded in sequence or in parallel, in any order.

In another embodiment, the processor may also present the Sponsorship Offer 206 record to the Consumer and invite the Consumer to review and either accept or reject the Sponsorship Offer 206 record (e.g., FIGS. 4 420 & 422). However, as a practical matter the implementer may treat the redemption of the code as acceptance of the associated Sponsorship Offer, thereby eliminating the need to present the Sponsorship Offer 206 record to the Consumer for acceptance.

The processor requests 504 Consumer Identification.

The processor may request 504 a specific type of Consumer Identification (e.g., an email address) or may request 504 that the Consumer provide any one of several specified types of Consumer Identification (e.g., an email address or a telephone number).

If the Consumer does not provide Consumer Identification (not illustrated), the transient Sponsorship Offer 206 record is optionally discarded and the process ends 524.

If the Consumer provides Consumer Identification, the processor determines 506 whether a Consumer 200 record containing that Consumer Identification exists.

If a Consumer 200 record containing the provided Consumer Identification exists 508, the processor loads 510 that Consumer 200 record.

If a Consumer 200 record containing the provided Consumer Identification does not exist 512, the processor creates 514 a Consumer 200 record containing the provided Consumer Identification.

The processor engages in Matching 516 the Consumer 200 Attributes and the Campaign 204 Attributes to verify that the Consumer is eligible for that Sponsorship.

Alternatively, the processor may engage in Matching 516 the Consumer 200 Attributes with the Attributes of the Sponsorship Offer 206 record, as the Sponsorship Offer 206 record inherits the Campaign 204 Attributes.

Optionally, the processor may skip this Matching process 516 (e.g., if the only requirement for a Sponsorship Offer under a Campaign is that the code be provided). However, in many cases, this Matching process is appropriate. For example, if a Campaign 204 record specifies that Sponsorship Offer 206 records that reference that Campaign 204 record may be presented only to a Consumer who provides the code and who has a telephone number with a certain area code (e.g., to limit the Sponsorship Offers to Consumers within a geographic area), then the processor must engage in Matching 516 the Consumer 200 Attributes (e.g., the area code of the provided telephone number) with the Campaign 206 Attributes.

Optionally, the processor may, after either loading 510 or creating 514 the Consumer 200 record, request additional information from the Consumer as desired by the Sponsor and/or implementer, or as required to determine eligibility for the Sponsorship Offer 206 record. For example, if the Consumer 200 record contains only an email address and the Campaign 204 record limits the presentation of Sponsorship Offer 206 records to Consumers with telephone numbers within a certain area code, the processor may, prior to engaging in Matching 516, prompt the Consumer to provide a telephone number.

Optionally, the processor may, prior to engaging in Matching 516, verify information in the Consumer 200 record as required by the Campaign 204 Attributes. For example, if the Sponsorship is limited to Consumers with verified telephone numbers within a certain area code, and the Consumer 200 record contains a telephone number within that area code, but that telephone number has not been verified, the processor may, prior to engaging in Matching 516, send a verification SMS message to that telephone number. Verification of Consumer Identification data may be helpful in reducing consumer fraud. Any method of verification may be used (e.g., sending an email to the Consumer with a link to select, or sending an SMS to the Consumer's telephone number with a verification code to enter on a specified web page), and one of ordinary skill in the art will recognize the many methods of verification available.

If the Consumer 200 Attributes do not Match 518 the Campaign 206 Attributes, the transient Sponsorship Offer 206 record is optionally discarded, and the process ends 524.

Alternatively, rather than ending the process 524, the processor may load other Campaign 204 records that reference the Sponsor 202 record to determine whether the Consumer is eligible for any Sponsorship Offer 206 records under the Sponsor's other Campaigns.

If the Consumer 200 Attributes Match 520 the Sponsorship 206 Attributes, the processor creates 522 a Sponsorship 206 record that references both the Consumer 200 record and the Campaign 204 record, and optionally the Sponsor 202 record. The implementer may optionally include additional Attributes as metadata of the Sponsorship 206 record (e.g., an expiration date or the time of creation).

The transient Sponsorship Offer 206 record is optionally discarded, and the process ends 524.

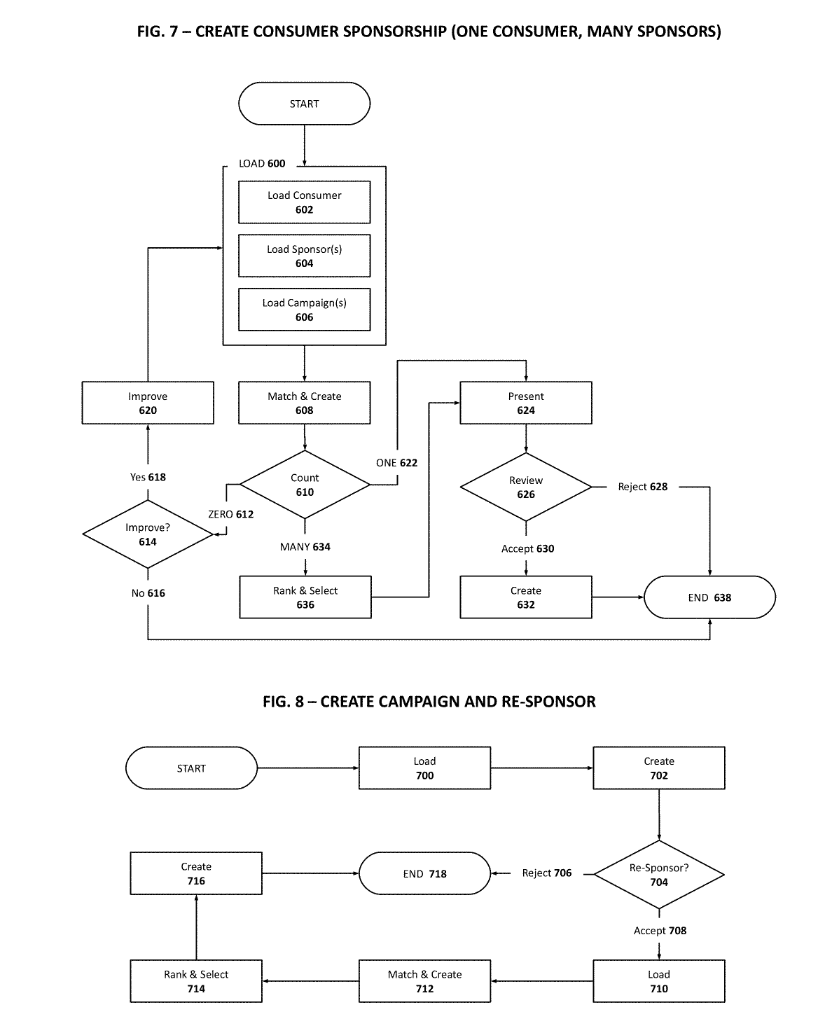

FIG. 7—Create Consumer Sponsorship (One Consumer, Many Sponsors)

A Consumer may request to see all Sponsorship Offers, from all potential Sponsors, available to that Consumer at a particular time. In another embodiment, a Consumer may request to see Sponsorship Offers from a subset of all potential Sponsors (e.g., request to see Sponsorship Offers from all local Sponsors).

The processor loads 600 the Consumer 200 record 602, all Sponsor 202 record(s) 604, and all Campaign 204 record(s) 606. The records may be loaded in sequence or in parallel, in any order.

The processor engages in Matching 608 the Consumer 200 Attributes with the Attributes of each Campaign 204 record (with each Campaign 204 record inheriting the Attributes of its referenced Sponsor 202 record) and creates 608 a transient set of Sponsorship Offer 206 records corresponding to each Match identified during that process. One of ordinary skill in the art will recognize how more complex Matching may be performed.

The processor counts 610 the number of Sponsorship Offer 206 records in the set of Sponsorship Offer 206 records created during the Matching process 608.

If the set of Sponsorship Offer 206 records contains zero Sponsorship Offer 206 records 612, the processor invites 614 the Consumer to improve the Consumer 200 record in order to determine whether there are other Sponsorship Offer 206 records for which the Consumer is eligible.

If the Consumer chooses not to improve 616 the Consumer 200 record, the process ends 638.

If the Consumer chooses to improve 618 the Consumer 200 record, the processor requests 620 additional information from the Consumer and adds 620 appropriate Attributes to the Consumer 200 record. Obvious Attributes include age, gender, interests, location, etc., and one of ordinary skill in the art will be able to identify and utilize other Attributes that may be used to profile a Consumer.

Optionally, the processor may request 620 specific information from the Consumer (e.g., “Are you male or female?”), or may provide 620 the Consumer with a number of queries (e.g., fields where the Consumer can provide age, birth month, location, or type of employment) and allow 620 the Consumer to choose which information to provide.

Optionally, the processor may also disclose 620 to the Consumer which types of information will best improve the Consumer 200 record for the purpose of acquiring Sponsorship Offers (e.g., “Providing your gender will make 11 Sponsorship Offers available” or “Adding your location will increase your chances of getting a Sponsorship by 75%”). After Attributes are added 620 to the Consumer 200 record, the process may end (not illustrated) or restart 600.

Optionally, the invitation to improve 614 the Consumer 200 record and the request for additional information 620 may be presented to the Consumer as a single step.

If the set of Sponsorship Offer 206 records contains exactly one Sponsorship Offer 206 record 622, the processor presents 624 that Sponsorship Offer 206 record to the Consumer.

The Consumer reviews 626 that Sponsorship Offer 206 record and either rejects 628 or accepts 630 it.

If the Consumer rejects 628 the Sponsorship Offer 206 record, the transient Sponsorship Offer 206 record is optionally discarded and the process ends 638.

Alternatively, rather than ending 638 the process, the processor may invite 614 the Consumer to improve the Consumer 200 record in order to determine whether there are other Sponsorship Offer 206 records for which the Consumer is eligible.

If the Consumer accepts 630 the Sponsorship Offer 206 record, the processor creates 632 a permanent Sponsorship 206 record that references both the Consumer 200 record and the Campaign 204 record, and optionally the Sponsor 202 record. The implementer may optionally include additional Attributes as metadata of the Sponsorship 206 record (e.g., an expiration date or the time of creation).

The transient Sponsorship Offer 206 record is optionally discarded, and the process ends 638.

If the set of Sponsorship Offer 206 records contains multiple Sponsorship Offer 206 records 634, the processor Ranks 636 the Sponsorship Offer 206 records.

Obvious methods of Ranking 636 include sorting by the dates the referenced Campaign 204 records were created, by Original Balances, or even randomly. The Ranking and selection 636 of Sponsorship Offer 206 records may incorporate the preferences of the Consumer, Sponsors, and/or implementer. One of ordinary skill in the art will recognize the many methods available to Rank 636 the Sponsorship Offer 206 records and select Sponsorship Offer 206 records for presentation to the Consumer.

The processor selects 636 and presents 624 to the Consumer one or more of the Sponsorship Offer 206 records.

The implementer may use any method of selecting 636 Sponsorship Offer 206 records for presentation 624 to the Consumer. For example, the processor may shortlist the Ranked Sponsorship Offer 206 records to yield a smaller subset to be presented to the Consumer (e.g., selecting the top ten or selecting Sponsorship Offers that reference the least-used or most recently created Campaign 204 records).

The processor may present 624 the selected Sponsorship Offer 206 record(s) to the Consumer in any manner, including randomly, according to their Rank as determined by the Ranking process 636, or by type of Sponsor or Sponsorship.

In another embodiment, the processor may present 624 to the Consumer two or more Sponsorship Offers, of which the Consumer may select only one. For example, the processor may invite the Consumer to choose between Sponsorship Offers from competing soft drink brands. This approach embodies a more reliable indication of Consumer preference than is revealed by having the Consumer choose from a group of Sponsorship Offers.

In another embodiment, the processor may present 624 Sponsorship Offer 206 records by the type of Sponsor (e.g., “Sponsorship from a Local Restaurant” rather than a specific Sponsorship Offer).

One of ordinary skill in the art will recognize multiple methods for selecting 636 the Sponsorship Offer 206 record(s) for presentation 624 to the Consumer, each of which may incorporate the preferences of the Consumer, Sponsors, and/or implementer.

The Consumer reviews 626 the presented Sponsorship Offer 206 record(s) and either rejects 628 all of them or accepts 630 one or more.

If the Consumer rejects 628 all of the presented Sponsorship Offer 206 record(s), the transient Sponsorship Offer 206 record(s) are optionally discarded and the process ends 638.

If the Consumer accepts 630 one or more Sponsorship Offer 206 record(s), the processor creates 632 one or more Sponsorship 206 record(s) (e.g., one Sponsorship 206 record for each Sponsorship Offer accepted). Each created Sponsorship 206 record references both the Consumer 200 record and the Campaign 204 record, and optionally the Sponsor 202 record referenced by that Campaign 204 record. The implementer may optionally include additional Attributes as metadata of the Sponsorship 206 record (e.g., an expiration date or the time of creation).

Optionally, the processor may place conditions on the Consumer's acceptance 630 of Sponsorship Offers (e.g., the Consumer may accept no more than five Sponsorship Offers, or the Consumer may not accept Sponsorship Offers from competing brands).

The transient Sponsorship Offer 206 records are optionally discarded, and the process ends 638.

While the process has been presented here in detail, one of ordinary skill in the art will recognize that the loading, Matching, Ranking, and other steps in this process may be done in many different combinations and/or sequences. For example, one could load 600 the Consumer 200 record, Sponsor 202 records, and Campaign 204 records, Match 608 Consumer 200 Attributes and the Attributes of each Campaign 204 record to create a set of Sponsorship Offer 206 records, count the records in the set, and Rank and select Sponsorship Offer 206 records 636 in a single step (e.g., using a complex SQL query).

FIG. 8—Create Campaign and Re-Sponsor

During the creation of a Campaign by a Sponsor, it may be beneficial to the Sponsor to automatically issue new Sponsorships to some or all Consumers with existing Sponsorships (“Re-Sponsoring”). For example, the Sponsor may want to give all Consumers with existing Sponsorships a special Sponsorship during a holiday season.

The processor loads 700 the Sponsor 202 record.

The processor creates 702 a Campaign 204 record including optional metadata defined by the Sponsor describing the Campaign.

The optional metadata of the new Campaign 204 record may include Attributes that define what type of Consumers a Sponsorship Offer 206 record that references that Campaign 204 record may be presented to, or when a Sponsorship 206 record that references that Campaign 204 record may be used. For example, in the case of a special holiday Campaign, the Sponsor may specify that Sponsorship Offers for the Campaign may be presented only between December 20 and December 25, and that Sponsorships that reference that Campaign expire on December 31. For another example, the Sponsor may specify that Sponsorship Offers for the Campaign may be presented only to female Consumers.

All such parameters governing the presentation of Sponsorship Offers and the use of Sponsorships for the Campaign are stored as Attributes of that Campaign 204 record. Such Campaign 204 Attributes will typically (but not necessarily) be inherited by Sponsorship 206 records that reference that Campaign 204 record.

The processor presents 704 the Sponsor with an option to automatically Re-Sponsor, under the new Campaign 204 record, Consumers who have existing Sponsorships with the Sponsor.

If the Sponsor rejects 706 the option to Re-Sponsor Consumers, the process ends 718.

If the Sponsor accepts 708 the option to Re-Sponsor Consumers, the processor loads 710 the Campaign 204 record(s) that reference that Sponsor 202 record, each Sponsorship 206 record that references each Campaign 204 record, and each Consumer 200 record referenced in each Sponsorship 206 record. The records may be loaded in sequence or in parallel, in any order.

The processor engages in Matching 712 the Attributes of the new Campaign 204 record with Attributes of each Consumer 200 record and creates 712 a set of Consumer 200 records corresponding to each Match identified during that process. The resulting set contains each Consumer 200 record that is eligible for a Sponsorship Offer 206 record that references the new Campaign 204 record.

For example, if there are 10,000 Consumer 200 records, the new Campaign 204 record specifies that the Consumer's location must be New York, and 1,000 of the Consumer 200 records indicate that the Consumer is located in New York, then the set created 712 contains only those 1,000 Consumer 200 records.

The processor Ranks 714 the Consumer 200 records contained in the set and, if necessary or desired, selects 714 a subset of Consumer 200 records based upon criteria defined by the Sponsor. Common methods may include Ranking by the age of the relationship between each Consumer and the Sponsor, or on the Consumer's annual spend. One of ordinary skill in the art will recognize that many methods of Ranking and selecting 714 potential Consumers to receive Sponsorships under the new Campaign 204 record are possible.

Optionally, the processor may present the results of the Ranking 714 of the set or subset of Consumer 200 records to the Sponsor to enable the Sponsor to review, limit, or abandon the Re-Sponsoring. For example, the Sponsor may instruct the processor to issue new Sponsorships only to Consumers who have used more than 50 percent of the Original Balance(s) of their existing Sponsorship(s) with that Sponsor. Optionally, the Sponsor may manually select certain Consumers to receive the new Sponsorship.

From the selected set or subset of Consumer 200 records, the processor creates 716 one or more Sponsorship 206 record(s) (e.g., one Sponsorship 206 record for each selected Consumer 200 record). Each created Sponsorship 206 record references both the Consumer 200 record and the Campaign 204 record. The implementer may optionally include additional Attributes as metadata of the Sponsorship 206 record(s) (e.g., an expiration date or the time of creation).

The process ends 718.

When a Sponsorship 206 record is created 716, it may also optionally directly reference the Sponsor 202 record. If the Sponsorship 206 record does not directly reference the Sponsor 202 record, the Sponsor 202 record may be inferred via the referenced Campaign 204 record, as each Campaign 204 record references exactly one Sponsor 202 record.

In another embodiment, during the Campaign creation, the processor may present to the Sponsor filters or other conditions for Re-Sponsoring. One of ordinary skill in the art will recognize that additional filters may be added to define which Consumers will be Re-Sponsored.

In another embodiment, the Sponsor may initiate the Re-Sponsoring process with reference to an existing Campaign rather than during creation of a new Campaign.

The ability to Re-Sponsor Consumers is advantageous to Sponsors because it enables a Sponsor to continue a relationship with a Consumer without requiring additional action by the Consumer. For example, through Re-Sponsoring a Consumer may receive multiple Sponsorships from a Sponsor over an extended period without ever knowing about the individual Sponsorships or Campaigns. Optionally, the implementer may allow a Consumer to prevent Re-Sponsoring of that Consumer, with respect to certain Sponsors or all Sponsors.

While the process has been presented here in detail, one of ordinary skill in the art will recognize that the loading, Matching, Ranking, and other steps in this process may be done in many different combinations and/or sequences. For example, one could load 710 the Campaign 204 record(s), Sponsorship 206 record(s), and Consumer 200 records, Match 712 Consumer 200 Attributes and the new Campaign 204 Attributes to create a set of Consumer 200 records, and Rank and select Consumers 714 in a single step (e.g., using a complex SQL query).

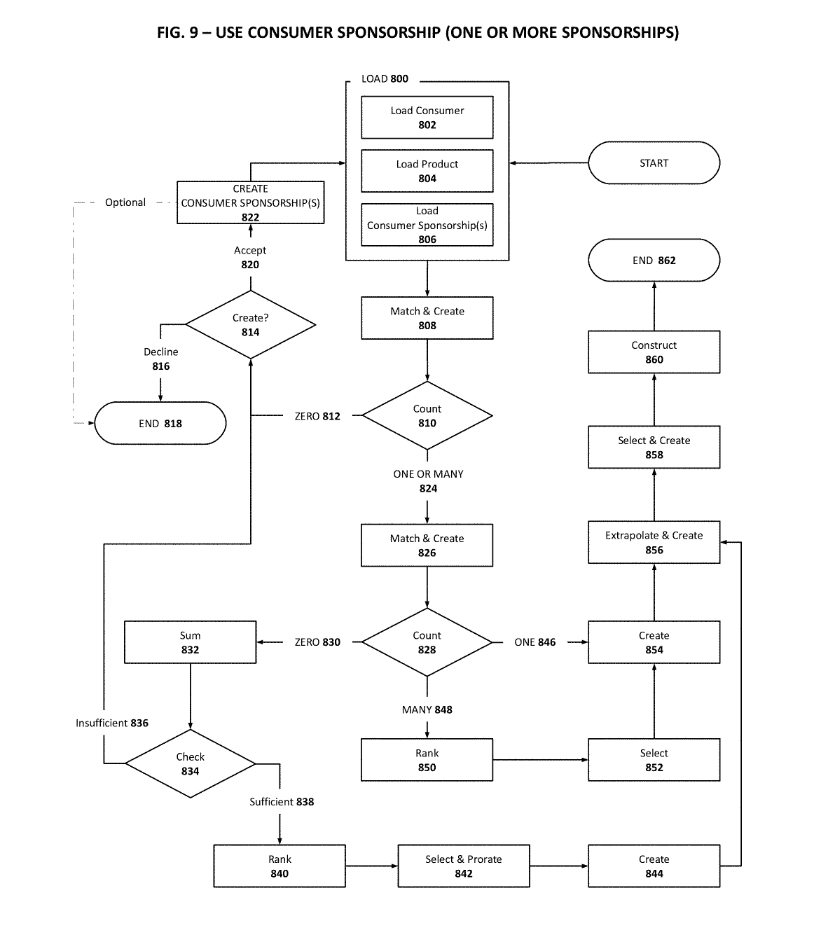

FIG. 9—Use Consumer Sponsorship (One or More Sponsorships)

The following embodiment illustrates the selection and use of Sponsorships in a market in which more than one Sponsorship may be used in order to access a single Product. For example, if the Price of a Product is $2.00, two Sponsorships—each worth $1.00—may be used for the purchase of that Product. The following embodiment illustrates how more than one Sponsorship may be used to access a single Product.

A Consumer requests to use a Sponsorship for the purchase of a Product (e.g., to play a music video with a Price of $0.025) (not illustrated). The Consumer may initiate the request directly (e.g., by selecting “Use Sponsorship” on a web page), or through a third party acting on behalf of the Consumer (e.g., via an API request).

The processor loads 800 the Consumer 200 record 802, the Product 210 record 804, and all Sponsorship 206 record(s) 806 that reference that Consumer 200 record. The records may be loaded in sequence or in parallel, in any order.

The processor engages in Matching 808 the Consumer 200 Attributes and the Product 210 Attributes with the Attributes of each Sponsorship 206 record, and creates 808 a set of Sponsorship 206 records corresponding to each Match identified during that process (the “First Set”).

The First Set contains each Sponsorship 206 record that is available for use by that Consumer to purchase that Product at that time. For example, if there are a total of five Sponsorship 206 records loaded, of which three may be used by the Consumer to purchase the Product at that time, then the First Set contains only those three Sponsorship 206 records.

The Matching 808 may be simple, such as checking only whether a Sponsorship 206 record may be used for the specific Product (e.g., if the Product is a movie with an R-rating and a Sponsorship 206 record does not permit the Sponsorship to be used in the purchase of R-rated Products, that Sponsorship 206 record would not be included as a Match in the First Set).

The Matching 808 may be more complex, such as checking whether a Sponsorship 206 record has any restriction on the frequency of its use that the requested purchase would violate (e.g., the Sponsorship cannot be used more than once during any 24-hour period and has already been used within the previous 24 hours). One of ordinary skill in the art will recognize how more complex Matching may be performed.

The processor counts 810 the number of Sponsorship 206 records in the First Set.

If the First Set contains zero Sponsorship 206 records 812, the processor invites 814 the Consumer to improve the Consumer 200 record in order to create additional Sponsorship 206 records.

If the Consumer declines to improve the Consumer 200 record 816, the process ends 818.

If the Consumer chooses to improve the Consumer 200 record 820, the processor begins a CREATE SPONSORSHIP(S) process 822 (e.g., FIG. 4 or FIG. 7).

Optionally, the processor may filter the Sponsorship Offer 206 record(s) that are presented to the Consumer during the CREATE SPONSORSHIP(S) process by excluding those Sponsorship Offer 206 record(s) that cannot be used by that Consumer to purchase that Product at that time. For example, if the Product is R-rated, the processor may modify the CREATE SPONSORSHIP(S) process by applying an additional filter so that only Sponsorship Offer 206 records that may be used on R-rated Products are presented to the Consumer (e.g., a Sponsorship Offer that would otherwise be presented to that Consumer will not be presented on this occasion if it cannot be used to purchase R-rated Products).

Alternatively, the processor may automatically initiate 822 a CREATE SPONSORSHIP(S) process without Consumer input (e.g., if the First Set contains zero records, the processor automatically prompts the Consumer for additional information, such as location or age).

Alternatively, the processor may automatically check for any Campaign 204 records under which Sponsorships are available to the Consumer at that time based on the existing Consumer 200 record (optionally filtered to exclude those Sponsorships that cannot be used to purchase the desired Product at that time) and may automatically present them to the Consumer for selection, or may automatically select one or more of them on behalf of the Consumer.

After any CREATE SPONSORSHIP(S) process is executed to completion, the Consumer is returned to the current method.

Alternatively, rather than the Consumer being invited 814 to improve the Consumer 200 record, the process may end 818.

If the First Set contains one or more Sponsorship 206 records 824, the processor engages in Matching 826 to determine whether the Balance of each Sponsorship 206 record contained in the set is greater than or equal to the Product 210 Price.

For example, if the Product 210 Price is $1.00 and the First Set contains one Sponsorship 206 record, the processor engages in Matching 826 the Product 210 Price of $1.00 with the Balance of that Sponsorship 206 record. If the Balance of that Sponsorship 206 record is $1.50, there is a Match (i.e., the Balance of the Sponsorship 206 record is greater than or equal to the Product 210 Price). If the Balance of that Sponsorship 206 record is $0.75 (e.g., less that the Product 210 Price), there is no Match.

The processor creates 826 a set containing each Sponsorship 206 record with a Balance greater than or equal to the Product 210 Price (the “Second Set”). For example, if the Product 210 Price is $0.05, the First Set contains five Sponsorship 206 records, and three of the Sponsorship 206 records in the First Set have Balances greater than or equal to $0.05, then the Second Set contains only those three Sponsorship 206 records.

However, other implementations may involve more complex Matching to meet the needs of the implementer and/or Sponsors. For example, the Balance of a Sponsorship 206 record may be limited by other Attributes (e.g., a Sponsorship 206 record has a Balance of $1.00, but other Attributes limit the use of that Sponsorship such that no more than $0.10 may be used for a single Transaction).

For another example, a Sponsor may limit the amount of a Sponsorship that may be used in a given time period (e.g., the Balance of the Sponsorship is $10.00, but other Attributes limit the use of that Sponsorship such that no more than $0.50 may be used in a 24-hour period, or such that no more than 10 percent of the Original Balance may be used within any seven-day period).

In implementations where the Balance is not the only Attribute that must be checked, the processor will determine whether the amount of the Balance that is available for use at that particular time on that particular product (rather than the total Balance of the Sponsorship) is greater than or equal to the Product 210 Price. Such implementations, involving checking more than one Attribute of Sponsorship 206 records and limiting use of the Sponsorship accordingly, allow the Sponsors and/or implementer to meet specific goals (e.g., delivering Interstitial Products to the Consumer at defined intervals or making a Sponsorship last for a minimum period of time).

In another embodiment, the processor may check the Balance of Sponsorship 206 records as part of the process of Matching 808 the Consumer 200 Attributes and the Product 210 Attributes with the Attributes of each Sponsorship 206 record and creating 808 a set of Sponsorship 206 records corresponding to each Match identified during that process.

The Second Set contains each Sponsorship 206 record with a Balance greater than or equal to the Product 210 Price. For example, if the Product 210 Price is $1.00, the First Set contains ten Sponsorship 206 records, and four of those Sponsorship 206 records have Balances of $1.00 or more, then the Second Set contains only those four Sponsorship 206 records. While every Sponsorship 206 record in the First Set may be used toward the purchase of the Product, every Sponsorship 206 record in the Second Set is individually sufficient to purchase the Product.

The processor counts 828 the number of Sponsorship 206 records in the Second Set.

If the Second Set contains exactly one Sponsorship 206 record 846, the processor creates 854 a Transaction 208 record that references that Sponsorship 206 record and the Product 210 record, and deducts the Product 210 Price from the Balance of the Sponsorship 206 record.

For example, if the Product 210 Price is $0.25 and the Sponsorship 206 record has a Balance of $1.00, then the processor creates a Transaction 208 record and deducts $0.25 from the Balance of the Sponsorship 206 record, resulting in a new Balance of $0.75.

Optionally, the Transaction 208 record may also reference the Consumer 200 record, the Sponsor 202 record, and/or the Campaign 204 record. The implementer may optionally include additional Attributes as metadata of the Transaction 208 record (e.g., the time of creation).

The processor extrapolates 856 Interstitial Product 210 records from the Sponsorship 206 record and creates 856 a set of Interstitial Product 210 records (the “First IP Set”). This process may include loading referenced Campaign 204 and/or Sponsor 202 records and extracting Attributes that reference Interstitial Product 210 records in any or all loaded records. The records may be loaded in sequence or in parallel, in any order.

A single record may reference zero or more Interstitial Product 210 records. For example, a Sponsorship 206 record may reference three Interstitial Product 210 records, with each Interstitial Product 210 record accompanying the use of the Sponsorship 206 record under certain conditions (e.g., one Interstitial Product for the first use of the Sponsorship, a second Interstitial Product for uses of the Sponsorship that occur on weekdays during business hours, and a third Interstitial Product for uses of the Sponsorship at all other times).

The First IP Set 856 contains all of the Interstitial Product 210 records that may be included with that use of the Sponsorship 206 record, as determined by the Attributes of the Sponsor 202, Campaign 204, Sponsorship 206, and/or Interstitial Product 210 records. For example, a Sponsorship may have two referenced Interstitial Products (e.g., one Interstitial Product for use during the workweek and one Interstitial Product for use during the weekend). If the use of the Sponsorship occurs on a Tuesday, then the First IP Set will contain the workweek Interstitial Product record, but not the weekend Interstitial Product record.

The processor selects 858 one or more of the Interstitial Product 210 records from the First IP Set and creates 858 a set containing those selected Interstitial Product 210 record(s) (the “Second IP Set”).

As a practical application, the processor may optionally Rank and/or limit the number of Interstitial Product 210 records selected 858 for inclusion in the Second IP Set. For example, the implementer may specify that only a single Interstitial Product may be included per use of the Sponsorship, or that only certain types of Interstitial Products may be included with certain Products (e.g., a long-form commercial Interstitial Product cannot be included with a short-form Product).

The selection 858 of Interstitial Product 210 records for inclusion in the Second IP Set may also consider other factors, such as the Consumer's age (e.g., an Interstitial Product that allows tracking of Consumer activity may not be included if the Consumer is under the age of 13) or recent Sponsorship experiences (e.g., if the Consumer has recently received a certain number of video-form Interstitial Products with the use of Sponsorships, the implementer may favor a static image Interstitial Product in order to optimize the Consumer's overall experience). One of ordinary skill in the art will recognize the many variations and limitations that may be applied to the Ranking and/or selection 858 of Interstitial Product 210 records for inclusion in the Second IP Set.

The processor constructs 860 a Uniquely Structured Document that references the Product 210 record and each Interstitial Product 210 record in the Second IP Set. The Uniquely Structured Document may optionally include all or a portion of the Product 210 record and the Interstitial Product 210 record(s) (e.g., in an XML data contract).

After constructing 860 the Uniquely Structured Document, the processor returns (e.g., sends via communication network) the Uniquely Structured Document to the Consumer and the process ends 862.

If the Second Set contains more than one Sponsorship 206 record 848, the processor Ranks 850 the Sponsorship 206 records in the Second Set and selects 852 one Sponsorship 206 record for use.

The processor may use any method to Rank 850 the Sponsorship 206 records and select 852 a Sponsorship 206 record for use.

For example, the processor may Rank 850 the Sponsorship 210 records randomly, or it may Rank 850 the Sponsorship 206 records based on a certain Attribute, such as age of the Sponsorship 206 record or time elapsed since last use.

For another example, if the implementer prefers certain types of Interstitial Product 210 records, the processor may Rank 850 the Sponsorship 206 records by the types of Interstitial Product 210 records referenced (e.g., Sponsorships with splash screen Interstitial Product 210 records are Ranked above Sponsorships with video Interstitial Product 210 records).

The processor may incorporate the preferences of the Consumer, Sponsors, and/or implementer in Ranking 850 the Sponsorship 206 records and selecting 852 a Sponsorship 206 record for use. One of ordinary skill in the art will recognize many variations and methods for Ranking 850 Sponsorship 206 records and selecting 852 a Sponsorship 206 record for use.

One improvement on this Ranking 850 process is to utilize an auction as a method of Ranking. In an auction method of Ranking, the processor would check the Attributes of each Sponsorship 206 record in the Second Set to determine the maximum amount each Sponsorship 206 record is permitted to pay for that Product at that time, and accordingly Rank 850 the Sponsorship 206 records in descending order. The processor would select 852 the top-Ranked Sponsorship 206 record, and calculate the Product 210 Price by adding the minimum incremental amount allowed in the auction to the maximum amount the second-Ranked Sponsorship 206 record is permitted to pay for the Product.

For example, if the Second Set contains five Sponsorship 206 records, the processor checks the Attributes of each Sponsorship 206 record to determine the maximum amount each Sponsorship 206 record is permitted to pay for that Product at that time and Ranks 850 the five Sponsorship 206 records in descending order (e.g., $5.00, $3.00, $2.00, $1.00, $0.50 in an auction in which the minimum increment is $0.25). The processor then selects 852 the $5.00 Sponsorship 206 record and calculates the Product 210 Price as $3.25, the second-highest bid of $3.00 plus the minimum increment of $0.25.

An auction approach to Ranking 850 Sponsorship 206 records results in a higher Price for the Product in that Transaction, and may be appropriate when multiple Sponsors are competing for access to a desired Consumer.

In implementations that use auction methods, Attributes that control how the Sponsorship 206 records are used in auctions may be added to the Sponsorship 206 and/or Campaign 204 and/or Sponsor 202 records (in which case, the Sponsorship 206 record inherits those Campaign 204 Attributes and/or Sponsor 202 Attributes).

For example, a Sponsor may decline to participate in auctions entirely, or may set limits on bids (e.g., the Sponsor is unwilling to pay more than $0.10, or is unwilling to pay more than 125% of the non-auction Product 210 Price). For another example, a Sponsor may allow its Sponsorships to be used in auctions only when another specific Sponsor is participating (e.g., Brand A's Sponsorships may be used only in auctions when competing Brand B's Sponsorships are used, or only when Brand B's Sponsorship would otherwise win the auction). For another example, the Sponsor may specify that only certain Campaigns (and therefore only Sponsorship 206 records that reference those Campaign 204 records) may be used in auctions.

The processor selects 852 the top-Ranked Sponsorship 206 record from the Second Set.

The processor creates 854 a Transaction 208 record that references that Sponsorship 206 record and the Product 210 record, and deducts the Product 210 Price from the Balance of the Sponsorship 206 record.

The processor extrapolates 856 Interstitial Product 210 records from the Sponsorship 206 record and creates 856 a First IP Set.

The processor selects 858 one or more of the Interstitial Product 210 records from the First IP Set and creates 858 a Second IP Set.

The processor constructs 860 a Uniquely Structured Document that references the Product 210 record and each Interstitial Product 210 record in the Second IP Set. After construction, the processor returns (e.g., sends via communication network) the Uniquely Structured Document to the Consumer and the process ends 862.

If the Second Set contains zero Sponsorship 206 records 830, then no Sponsorship 206 record in the First Set has a Balance greater than or equal to the Product 210 Price. Because no one Sponsorship 206 record in the First Set has a sufficient Balance to purchase the Product, the processor checks whether any combination of Sponsorship 206 records in the First Set has a sufficient summed Balance to purchase the Product.

The processor sums 832 the Balances of all Sponsorship 206 records in the First Set.

For example, if there are three Sponsorship 206 records in the First Set, with Balances of $0.01, $0.03, and $0.04, respectively, and the Product 210 Price is $0.05, the processor sums 832 the three Balances ($0.01, $0.03, and $0.04).

The processor determines 834 whether the sum of the Balances of the Sponsorship 206 records in the First Set is greater than or equal to the Product 210 Price.

If the sum is greater than or equal to the Product 210 Price, then at least one combination of the Sponsorship 206 records in the First Set may be used to purchase that Product (e.g., the summed Balance is sufficient for the purchase). For example, if the Product 210 Price is $0.05 and the sum of the Balances of the three Sponsorship 206 records in the First Set is $0.08, then the sum of the Balances of Sponsorships is sufficient to cover the Product 210 Price.

If the sum of the Balances of all Sponsorship 206 records in the First Set is less than the Product 210 Price 836, then no individual Sponsorship 206 record or combination of Sponsorship 206 records may be used to purchase the Product.

The processor invites 814 the Consumer to create new Sponsorship 206 records.

If the Consumer declines 816 the invitation to create new Sponsorship 206 records, the process ends 818.

If the Consumer accepts 820 the invitation to create new Sponsorship 206 records, the processor initiates 822 a CREATE SPONSORSHIP(S) process (e.g., FIG. 4 or FIG. 7).

Alternatively, the processor may automatically initiate 822 a CREATE SPONSORSHIP(S) process without Consumer input.

Alternatively, rather than the Consumer being invited 814 to create new Sponsorship 206 records, the process may end 818.

If the sum of the Balances of the Sponsorship 206 records in the First Set is equal to or greater than the Product 210 Price 838, the processor Ranks 840 the Sponsorship 206 records.

A simple method of Ranking 840 is to sort Sponsorship 206 records by Balance in descending order (e.g., a Sponsorship with a $1.00 Balance Ranks above a Sponsorship with a $0.99 Balance). One of ordinary skill in the art will recognize that many other methods of Ranking may be implemented.

The processor selects 842 a combination of Sponsorship 206 records from the First Set that has a summed Balance greater than or equal to the Product 210 Price and adds each of those Sponsorship 206 records to the previously-empty Second Set.

It is recommended that the Second Set contain the minimum number of Sponsorship 206 records necessary to reach a summed Balance greater than or equal to the Product 210 Price (e.g., select a combination that requires only two Sponsorship 206 records rather than a combination that requires three Sponsorship 206 records). For example, if the Product 210 Price is $1.00, and the Sponsorship records in the First Set have Balances of $0.80, $0.50, $0.40, $0.20, and $0.10, respectively, it is generally preferable to select a combination of two Sponsorship records (e.g., $0.80 and $0.50, $0.80 and $0.40, or $0.80 and $0.20) rather than a combination of three Sponsorship records (e.g., $0.50, $0.40, and $0.20, or $0.50, $0.40, and $0.10).

However, specific implementations may require alternative approaches to selecting 842 Sponsorship 206 records for the Second Set. For example, if two Sponsorship 206 records have a summed Balance greater than or equal to the Product 210 Price but may not be used together because they are from competing Sponsors who have set Attributes preventing such a combination, then the processor may select a combination of three Sponsorship 206 records as the preferred option. For another example, if the combination of the minimum number of Sponsorship 206 records would violate the implementer's preference that certain types of Interstitial Product 210 records may not used together with that Product 210 record, the processor may use other factors in selecting a combination of Sponsorship 206 records from the First Set for inclusion in the Second Set.

Sponsors may optionally limit the use of Sponsorship 206 records to meet the Sponsor's needs (e.g., define Campaign 204 Attributes that prevent Sponsorship 206 records that reference that Campaign from being used in conjunction with certain other Sponsorship 206 records).

The implementer may also optionally set conditions on the use of multiple Sponsorship 206 records, such as a limitation that no more than three Sponsorship 206 records may be used for any one purchase, or that certain types of Interstitial Product 210 records may not be delivered together. More complex conditions are possible, such as a condition that applies only under certain circumstances (e.g., two video Interstitial Product 210 records may not be selected if the Consumer has already received five video Interstitial Product 210 records within the past hour). The processor may consider other factors and the preferences of the Consumer, Sponsors, and/or implementer in the selection 842 of Sponsorship 206 records for inclusion in the Second Set.

Optionally, the processor may also consider the preferences of the Product owner in the selection of Sponsorship 206 records for inclusion in the Second Set (e.g., the Product 210 Attributes may specify that no more than three Interstitial Product 210 records may accompany it, in which case the processor will not select a combination of Sponsorship 206 records that would require the selection of four or more Interstitial Product 210 records).

One of ordinary skill in the art will recognize the many variations and limitations that may be applied to the selection 842 of a combination of Sponsorship 206 records from the First Set for inclusion in the Second Set.

If the summed Balance of the Sponsorship 206 records in the Second Set is exactly equal to the Product 210 Price, there is no need for the processor to prorate 842 the Product 210 Price between the Sponsorship 206 records. For example, if the Product 210 Price is $1.00 and the two Sponsorship 206 records in the Second Set each have a Balance of $0.50, then no proration is required (e.g., each Sponsorship 206 record pays $0.50).

However, if the summed Balance of the Sponsorship 210 records in the Second Set is greater than the Product 210 Price, the processor prorates the Product 210 Price among the Sponsorship 206 records in the Second Set. For example, if the Product 210 Price is $1.00, and the three Sponsorship 206 records in the Second Set have Balances of $0.50, $0.40, and $0.30, respectively (e.g., 0.5+0.4+0.3=1.2), the processor assigns them prices of $0.417, $0.333, and $0.250, respectively.

The processor may use other methods of prorating 842 purchases between Sponsorship 206 records in the Second Set, and may incorporate the preferences of the Consumer, Sponsors, and/or implementer. For example, one Sponsorship 206 record may not permit more than a specified amount of the Balance to be applied to a purchase unless the Product 210 Price is being divided between fewer than three total Sponsorship 206 records (e.g., that Sponsorship 206 record may contribute more than $0.25 to a Product purchase only if the Product 210 Price is divided between no more than two other Sponsorship 206 records). One of ordinary skill in the art will recognize that many variations may be applied to the distribution of purchases between Sponsorship 206 records in the Second Set.

The processor creates 844 a separate Transaction 208 record that references each Sponsorship 206 record in the Second Set as well as the Product 210 record. For example, if the Second Set contains two Sponsorship 206 records, the processor creates 844 two Transaction 208 records (e.g., one that references the first Sponsorship 206 record and the Product 210 record, and one that references the second Sponsorship 206 record and the Product 210 record).

Optionally, the Transaction 208 records may also reference the Consumer 200 record, the Sponsor 202 record, and/or the Campaign 204 record. The implementer may optionally include additional Attributes as metadata of the Transaction 208 record (e.g., the time of creation).

Optionally, each Transaction 208 record may also reference the other Transaction 208 record(s) created for this purchase (e.g., if there are two Sponsorship 206 records in the Second Set, the processor creates two Transaction 208 records, each of which references the other).

The processor extrapolates 856 Interstitial Product 210 records from each of the Sponsorship 206 records in the Second Set and creates 856 a First IP Set.

The processor selects 858 one or more of the Interstitial Product 210 records from the First IP Set to create 858 a Second IP Set.

Optionally, the processor may implement a Ranking and/or auction process to select 858 Interstitial Product 210 records from the First IP Set for inclusion in the Second IP Set.

For example, if the Product may be accompanied by up to three Interstitial Product 210 records, only one of which may be a video Interstitial Product 210 record (e.g., the other two must be splash screens), then the processor may Rank the Interstitial Product 210 records in the First IP Set and select 858 the top-Ranked record. If there are three Sponsorship 206 records in the Second Set, each of which has a video Interstitial Product 210 record, and only one video Interstitial Product 210 record may be included with the Product 210 record, then the processor may use an auction method to determine which video Interstitial Product 210 record is selected 858 for inclusion in the Second IP Set. Sponsors may control their participation in such auctions through Attributes on the Sponsor 202, Campaign 204, Sponsorship 206, and/or Interstitial Product 210 records.

The processor constructs 860 a Uniquely Structured Document that references the Product 210 record and each Interstitial Product 210 record in the Second IP Set.

In another embodiment, the processor may implement a Ranking and/or auction process to determine the placement of each selected Interstitial Product 210 record in the Uniquely Structured Document.

For example, if the Product is a feature film and there are five selected Interstitial Product 210 records (one from each Sponsorship 206 record in the Second Set) that will be displayed at different times during the film, the processor may Rank the Interstitial Product 210 records to determine the order in which the Interstitial Product 210 records will be displayed during the film. As some placements are preferred over others (e.g., a placement at the beginning or middle of the film is preferred over a placement during the end credits), an auction method of Ranking may be appropriate.

After construction, the processor returns (e.g., sends via communication network) the Uniquely Structured Document to the Consumer and the process ends 862.

While the process has been presented here in detail, one of ordinary skill in the art will recognize that the loading, Matching, Ranking, and other steps in this process may be done in many different combinations and/or sequences. For example, one could load 800 the Consumer 200 record 802, Product 210 record 804, and Sponsorship 206 record(s) 806, match Attributes 808, and check Sponsorship Balances 826 in a single step (e.g., using a complex SQL query).

While currency (e.g., $0.016) is the preferred method of tracking Prices and Balances, other methods of tracking may be used (e.g., points per play, or some value derived retrospectively from prorating plays in a subscription, or different tiers of points such as bronze, silver, and gold).

In another embodiment, the processor may select more than one Sponsorship 206 record for use even where each Sponsorship 206 record has a Balance that is greater than or equal to the Product 210 Price. For example, two Sponsorships each having a Balance of $2.00 may be used for $0.50 each to purchase a $1.00 Product, where the Attributes of each Sponsorship 206 record provide that use of that Sponsorship in an increment of $0.50 or less will allow the accompanying Interstitial Product to be a splash screen rather than a 15-second video advertisement. If the Consumer or the implementer prefers splash screens over longer advertisements, the processor may select two Sponsorships rather than one to conform to that preference.

In another embodiment, the implementer may allow Sponsorships to be used to pay part of the Product 210 Price, rather than the entire Price. For example, if the Product 210 Price is $1.00, the Consumer may use a Sponsorship 206 record to pay $0.50 of the Price and may directly pay the remaining $0.50. The Consumer may request the use of Sponsorships to pay only a portion of the Product 210 Price (e.g., request to use Sponsorships to cover 50% of the purchase) and/or the processor may give the Consumer the option to pay directly a portion of the Price if the Consumer's Sponsorships are insufficient for the purchase (e.g., the sum of the Balances of all the Sponsorships in the First Set is less than the Product 210 Price 836).

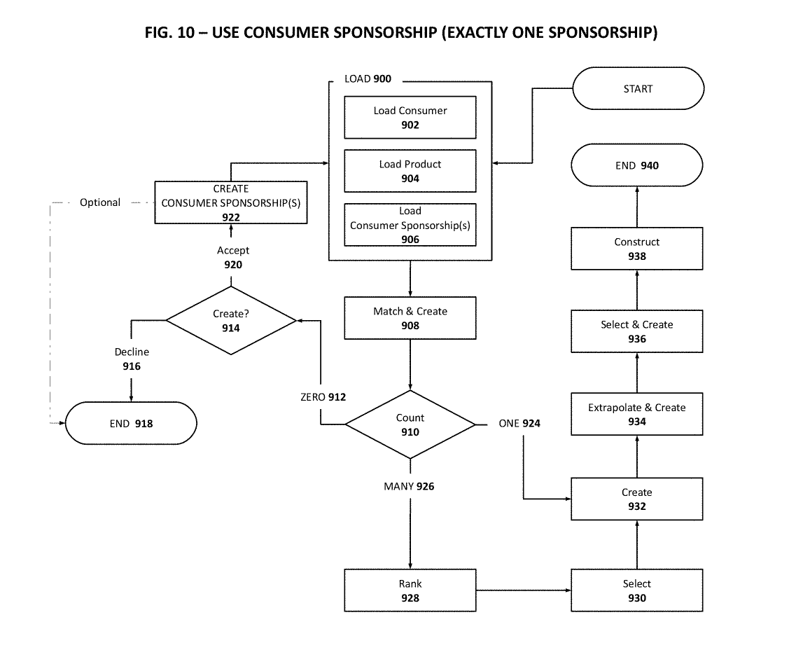

FIG. 10—Use Consumer Sponsorship (Exactly One Sponsorship Used)

The implementer may limit the use of Sponsorships such that only one Sponsorship may be used in any purchase of a Product. This implementation prevents the complexity associated with the use of multiple Sponsorship 206 records.

One approach to this implementation is to control the Product 210 Price and/or the Balances of Sponsorship 206 records, such that if a Sponsorship 206 record has a Balance, the Balance of that Sponsorship 206 record is necessarily sufficient to purchase the Product. For example, if every Product is priced at $0.01, and Sponsorships must be created with Balances in whole pennies (e.g., a Sponsorship may be created with an Original Balance of $0.05 or $0.06, but not with an Original Balance of $0.051 or $0.059), then every Sponsorship 206 record with a Balance will necessarily have a Balance sufficient to purchase any Product (e.g., every Sponsorship with a Balance has a Balance of at least $0.01 and every Product is priced at exactly $0.01). In such a case, it will never be necessary to use more than one Sponsorship to purchase a Product.

A Consumer requests to use a Sponsorship for the purchase of a Product (e.g., to play a music video with a Price of $0.025) (not illustrated). The Consumer may initiate the request directly (e.g., by selecting “Use Sponsorship” on a web page), or through a third party acting on behalf of the Consumer (e.g., via an API request).

The processor loads 900 the Consumer 200 record 902, the Product 210 record 904, and all Sponsorship 206 record(s) 906 that reference that Consumer 200 record. The records may be loaded in sequence or in parallel, in any order.

The processor engages in Matching 908 the Consumer 200 Attributes and the Product 210 Attributes with the Attributes of each Sponsorship 206 record and creates a First Set of Sponsorship 206 records corresponding to each Match identified during that process. The First Set contains every Sponsorship 206 record that is available for use by that Consumer to purchase that Product at that time, and that has a Balance greater than or equal to the Product 210 Price. This step may include Matching of other Attributes (e.g., Sponsorship expiration, Balance, day of week). One of ordinary skill in the art will recognize how more complex Matching may be performed.

If the market is fixed (e.g., the Product 210 Prices and the Balances of Sponsorship 206 records are controlled), it may not be necessary to check the Balance of each Sponsorship 206 record during Matching 908 (i.e., if a Sponsorship has a Balance greater than zero, then it can be used to purchase the Product).

The processor counts 910 the number of Sponsorship 206 records in the First Set.

If the First Set contains zero Sponsorship 206 records 912, the processor invites 914 the Consumer to improve the Consumer 200 record in order to create additional Sponsorship 206 records.

If the Consumer declines to improve 916 the Consumer 200 record, the process ends 918.

If the Consumer accepts 920 the invitation to create new Sponsorship 206 records, the processor initiates a CREATE SPONSORSHIP(S) process 922 (e.g., FIG. 4 or FIG. 7). In this instance, the processor may optionally filter the Sponsorship Offer 206 records that are presented to the Consumer by excluding those Sponsorship Offers that cannot be used by that Consumer to purchase that Product at that time. For example, if the Product is R-rated, the processor may modify the CREATE SPONSORSHIP(S) process by applying an additional filter so that only Sponsorships that may be used on R-rated Products are presented to the Consumer (i.e., a Sponsorship Offer that would otherwise be presented to that Consumer will not be presented on this occasion if it cannot be used to purchase R-rated Products).

Alternatively, rather than the Consumer being invited 914 to create new Sponsorship 206 records, the process may end 918.

Alternatively, the processor may automatically initiate a CREATE SPONSORSHIP(S) process without Consumer input (e.g., if the First Set contains zero records 912, the processor automatically prompts the Consumer for additional information, such as location or age).

Alternatively, the processor may automatically check for any Sponsorship Offer 206 records available to the Consumer at that time based on the current Consumer 200 record and may automatically present them to Consumer for selection, or may automatically select one or more of them on behalf of the Consumer.

After any CREATE SPONSORSHIP(S) process is executed to completion, the Consumer will be returned to the current method.

If the First Set contains exactly one Sponsorship 206 record 924, the processor creates 932 a Transaction 208 record that references that Sponsorship 206 record and the Product 210 record, and deducts the Product 210 Price record from the Balance of the Sponsorship 206 record. Optionally, the Transaction 208 record may also reference the Consumer 200 record, the Sponsor 202 record, and/or the Campaign 204 record. The implementer may optionally include additional Attributes as metadata of the Transaction 208 record (e.g., the time of creation).

The processor extrapolates 934 Interstitial Product 210 records from the Sponsorship 206 record and creates 934 a First IP Set. This may include loading the referenced Campaign 204 and/or Sponsor 202 records, and extracting Attributes that reference Interstitial Product 210 records in any or all loaded records. A single record may reference zero or more Interstitial Product 210 records. The records may be loaded in sequence or in parallel, in any order.

The processor selects 936 one or more of the Interstitial Product 210 records from the First IP Set and creates 936 a Second IP Set containing those selected records.

As a practical application, in selecting Interstitial Product 210 records for inclusion in the Second IP Set 936, the implementer may optionally Rank and/or limit the number of Interstitial Product 210 records selected for inclusion in the Second IP Set. For example, the implementer may specify that only a single Interstitial Product 210 record may be selected per use of a Sponsorship. The Ranking may also consider other factors and the preferences of the Consumer, Sponsor, and/or implementer. For example, the First IP Set may contain five Interstitial Product 210 records, each of which corresponds to a short commercial, in which case the implementer may Rank those Interstitial Product 210 records and select 936 only one for inclusion in the Second IP Set. One of ordinary skill in the art will recognize many variations and limitations that may be applied to the Ranking and/or selection 936 of Interstitial Product 210 records for inclusion in the Second IP Set.

The processor constructs 938 a Uniquely Structured Document that references the Product 210 record and each Interstitial Product 210 record in the Second IP Set. The Uniquely Structured Document may optionally include all or a portion of the Product 210 record and the selected Interstitial Product 210 record(s) (e.g., in an XML data contract).

After construction, the processor returns (e.g., sends via communication network) the Uniquely Structured Document to the Consumer and the process ends 940.

If there are multiple Sponsorship 206 records in the First Set 926, the processor Ranks 928 those Sponsorship 206 records and selects 930 one Sponsorship 206 record for use.

The processor may use any method to Rank 928 the Sponsorship 206 records and select 930 one Sponsorship 206 record for use.

Simple methods of Ranking 928 include sorting by the date each Sponsorship was created, Balance, or even randomly. For example, the processor may Rank 928 Sponsorship 206 records based on Attributes such as the age of each Sponsorship, the time elapsed since each Sponsorship was last used, or the type of Interstitial Product that accompanies each Sponsorship.

The processor may incorporate the preferences of the Consumer, Sponsors, and/or implementer in the Ranking 928 and selection 930. One of ordinary skill in the art will recognize many variations and methods for Ranking 928 Sponsorship 206 records and selecting 930 one Sponsorship 206 record for use.

The processor selects 930 the top-ranked Sponsorship 206 record.

The processor creates 932 a Transaction 208 record that references that Sponsorship 206 record and the Product 210 record, and deducts the Product 210 Price from the Balance of the Sponsorship 206 record. Optionally, the Transaction 208 record may also reference the Consumer 200 record, the Sponsor 202 record, and/or the Campaign 204 record. The implementer may optionally include additional Attributes as metadata of the Transaction 208 record (e.g., the time of creation).

The processor extrapolates 934 Interstitial Product 210 records from the Sponsorship 206 record and creates 934 a First IP Set.

The processor selects 936 one or more Interstitial Product 210 records from the First IP Set and creates 936 a Second IP Set containing those selected records.

The processor constructs 938 a Uniquely Structured Document that references the Product 210 record and each selected Interstitial Product 210 record.

After construction 938, the processor returns (e.g., sends via communication network) the Uniquely Structured Document to the Consumer and the process ends 940.

While the process has been presented here in detail, one of ordinary skill in the art will recognize that the loading, Matching, counting, and other steps in this process may be done in many different combinations and/or sequences. For example, one could load the Consumer 200 record 902, Product 210 record 904, and Sponsorship 206 record(s) 906, Match Attributes to create a set of Sponsorship 206 records 908, and determine the number of Sponsorship 206 records contained in that set 910, all in a single step (e.g., via a complex SQL query).

Consumer Automatically Accepts Sponsorships

In another embodiment, the Consumer may define Attributes that result in the automatic acceptance (“auto-accept”) of Sponsorship Offer 206 records. For example, the Consumer may choose to auto-accept any Sponsorship Offer 206 record related to basketball from any Sponsor in that Consumer's geographic area. These parameters for auto-acceptance would be stored as Attributes in the Consumer 200 record and used during Matching processes (e.g., FIG. 4 408 or FIG. 7 608).

In another embodiment, the processor may auto-accept, on behalf of the Consumer, all or some of the Sponsorship Offer 206 records for which a Consumer is eligible. Optionally, the implementer may make auto-acceptance of Sponsorship Offer 206 records a default setting of the Sponsorship System, in which case the Consumer may be able to opt out of the auto-accept feature.

Sponsorship Offer Based on Context

In another embodiment, API calls to create Sponsorship 206 records may include context Attributes that further limit Sponsorship Offers. For example, the context of the Consumer's being at a particular hotel or on flight to a particular city could be used to determine which Campaign 204 records may generate Sponsorship Offer 206 records for that Consumer at that time.

Such context Attributes may enable Sponsors to more specifically target Consumers for Sponsorship Offers.

For example, a restaurant in Denver may create a special Campaign under which Sponsorship Offers may be presented only to Consumers who are currently on flights to Denver, in which case a context Attribute (e.g., whether the Consumer is on a flight to Denver) is necessary to the presentation of a Sponsorship Offer 206 record that references that Campaign 204 record. In this embodiment, the context Attributes are matched (e.g., FIG. 4 408, FIG. 5 450, FIG. 6 516, FIG. 7 608) with Attributes of the Consumer 200 record, Campaign 204 record, and/or Sponsor 202 records. One of ordinary skill in the art will recognize the variations and limitations that may incorporate context Attributes.

Context Attributes may be included in an API call during a CREATE SPONSORSHIP(S) process (e.g., if the Consumer uses a seatback TV screen on an airplane to initiate the CREATE SPONSORSHIP(S) process).

Context Attributes may also be added directly to the Consumer 200 record (e.g., if the context Attribute is the current location of the Consumer).

Physical Products and Physical Interstitial Products

In another embodiment, an existing Sponsorship held by a Consumer may be used to purchase a physical Product (e.g., a can of soda on an airplane, a cup of coffee in a store) and the Interstitial Products may be media based (e.g., delivered via an in-seat TV on an airplane or through a point of sale terminal in a store). In this embodiment, the Uniquely Structured Document may contain references to the physical Product and media Interstitial Products, and may be sent (e.g., FIGS. 9 856 & 860, FIGS. 10 934 & 938) to multiple parties (e.g., the airline crew and the airline entertainment provider).

In another embodiment, an existing Sponsorship held by a Consumer may be used to purchase a media Product (e.g., an in-flight movie) and the Interstitial Product may be physical (e.g., a snack provided). In this embodiment, the Uniquely Structured Document may contain references to the media Product and physical Interstitial Product, and may be sent (e.g., FIGS. 9 856 & 860, FIGS. 10 934 & 938) to multiple parties (e.g., the airline crew and the airline entertainment provider).

The embodiment tracks Transactions involving Products and Interstitial Products, where either may be physical, media, or even another process (e.g., permission to track the Consumer online).

Triggers to Add/Renew Sponsorships

One of ordinary skill in the art will recognize that triggers may be created to initiate any process based on some state.

For example, the implementer may create a trigger that automatically initiates a CREATE SPONSORSHIP(S) process when the summed Balances of all of a Consumer's Sponsorships falls below a certain level (e.g., when all of the Sponsorship 206 records that reference the Consumer 200 record have a summed Balance of less than $5.00).

For another example, a Sponsor may create a trigger for a Campaign such that when a Sponsorship 206 record that references that Campaign 204 record has been fully used (e.g., a Transaction brings the Balance to $0.00), the processor creates a new Sponsorship 206 record that references that Consumer 200 record and either the same or a different Campaign 204 record, and assigns an Original Balance in a pre-determined amount to the new Sponsorship 206 record. In this way, a specific Consumer may over time acquire multiple Sponsorship 206 records that reference the same Sponsor 202 record without any action by the Consumer or even any awareness by the Consumer of the process or of the various Sponsorships.

For example, if a Sponsor has two Campaigns, one for new Consumers and one for existing Consumers, a Consumer may first receive a Sponsorship 206 record that references the Campaign 204 record for new Consumers and then, when the Balance of that first Sponsorship 206 record is depleted, receive a new Sponsorship 206 record that references the Campaign 204 record for existing Consumers, without the Consumer knowing the terms of either Sponsorship 206 record or even knowing that he has received multiple Sponsorship 206 records from that Sponsor.

Similarly, a trigger may initiate a USE SPONSORSHIP process (e.g., FIG. 9 or FIG. 10). Such triggers may be created according to the preferences of the Consumer, Sponsors, and/or implementer.

Modify Sponsorship

One of ordinary skill in the art will recognize that Sponsorship 206 records may be modified.

For example, a Sponsor may change the settings on a Campaign 204 record (e.g., to add a condition that Sponsorship 206 records that reference that Campaign 204 record may not be used to purchase R-rated Products), and optionally those settings may be applied to existing as well as future Sponsorship 206 records that reference that Campaign 204 record.

For another example, a Sponsor may manually change the settings of a particular Sponsorship 206 record, without altering the referenced Campaign 204 record, based on characteristics of the specific Consumer 200 record associated with that Sponsorship 206 record (e.g., the Sponsor identifies a particularly valuable Consumer, such as a frequent patron of its business, and manually adjusts the Sponsorship 206 record that references that Consumer to increase the Balance or the frequency with which that Sponsorship may be used).

Additionally, a Sponsor may set triggers and conditions for automatically modifying Sponsorship 206 records. For example, the Sponsor may set as a Sponsor 202 Attribute that the Balance of any Sponsorship 206 record that references that Sponsor 202 record will be automatically reduced by 90% in the event that the Sponsorship 206 record has not been used (e.g., no Transaction 208 record has been created that references that Sponsorship 206 record) within a twelve-month period. In this case, the Sponsor 202 Attribute would be inherited by each Campaign 204 record that references that Sponsor 202 record.

For another example, a Sponsor may set as a Campaign 204 Attribute that if a Consumer that is referenced in a Sponsorship 206 record for that Campaign adds a loyalty number (e.g., frequent flyer number) to the Consumer 200 record, the Balance of the Sponsorship 206 record that references that Consumer 200 record is automatically doubled (i.e., “If you add your frequent flyer number to your profile, we'll double the value of your Sponsorship”).

While modification of an existing Sponsorship 206 record is possible, it is generally recommended that instead a new Sponsorship 206 record containing the new terms (Attributes) be created and that the original Sponsorship 206 record be inactivated and stored in its unmodified state so that a clear audit trail is created.

Consumer-Gifted Sponsorship

In another embodiment, a Sponsorship may be gifted from one Consumer to another.

For example, a Consumer who obtains a Sponsorship from a fitness club where he is a member may choose to gift that Sponsorship to another Consumer.

This embodiment may be implemented in various ways.

For example, the Consumer may browse their Sponsorship 206 records or referenced Sponsor 202 records, select one or more Sponsorship(s) to gift, and identify the receiving Consumer(s) (e.g., by email address, social relationship, telephone number).

In this example, the processor may either (a) change the Consumer 200 record reference on the Sponsorship 206 record from that of the gifting Consumer to that of the receiving Consumer; or (b) copy the Sponsorship 206 record to create a new Sponsorship 206 record that references the Consumer 200 record of the receiving Consumer, and optionally discard the Sponsorship 206 record that references the Consumer 200 record of the gifting Consumer; or (c) if the Campaign 204 and Sponsor 202 Attributes permit, create an entirely new Sponsorship 206 record using the referenced Campaign 204 record of the gifting Consumer's Sponsorship.

One of ordinary skill in the art will recognize that variations on these methods are possible within the spirit of this disclosure.

Consumer-Gifted Product

In another embodiment, a Product purchased by one consumer using a Sponsorship may be gifted to another Consumer.

This embodiment may be implemented in various ways.

For example, the gifting Consumer may gift a song to the receiving Consumer and choose (or allow the processor to choose) to use at least one Sponsorship to purchase the Product.

In this example, the gifting Consumer would receive any associated Interstitial Product 210 record(s) as a precondition for the receiving Consumer to receive the gifted Product 210 record. Once the condition(s) of the purchase were satisfied, the receiving Consumer would receive notification of the gift (e.g., via email), including the identity of the gifting Consumer and the Sponsor(s) whose Sponsorship 206 record(s) were used to purchase the Product 210 record.

One of ordinary skill in the art will recognize that variations on these methods are possible within the spirit of this disclosure.

Consumer-Gifted Sponsorship with Referral Reward Sponsorship

In another embodiment, the gifting methods disclosed may include creation of a Referral Reward Sponsorship.

This embodiment may be implemented in various ways.

For example, a Consumer who is a member of a fitness club gifts a Sponsorship from that Sponsor to another Consumer and receives, as a reward, a new Sponsorship (from the fitness club or from another Sponsor who is partnered with the fitness club).

In this example, when the gifting Consumer gifts a Sponsorship 206 record to the receiving Consumer, the processor creates a new Sponsorship 206 record for the gifting Consumer that references the Referral Reward Sponsorship.

One of ordinary skill in the art will recognize that variations on these methods are possible within the spirit of this disclosure.

Partner Product as Interstitial Product

In another embodiment, a Sponsor may include a partner's Interstitial Product with the use of the Sponsor's Sponsorship.

This embodiment may be implemented in various ways.

For example, if a large soft drink manufacturer Sponsor wants to support an up-and-coming artist, the Sponsor's Campaign 204 records would reference that artist's new song (i.e., reference an Interstitial Product 210 record containing that song). When Sponsorships that reference those Campaign 204 records are used, the artist's song will be included in the Uniquely Structured Document.

In this example, the processor would add to Campaign 204 and/or Sponsor 202 records Attributes that reference the Sponsor 202, Campaign 204, or Product 210 records of the partner (i.e., the artist). When a Sponsorship 206 record is used (e.g., FIG. 9 or FIG. 10), the Campaign 204 record is loaded, and Attributes that reference the partner's Sponsor 202, Campaign 204, and/or Product 204 records are extrapolated and loaded into a larger set of Campaign 204 records, which are subsequently used during extrapolation of Sponsorship 206 records into Interstitial Product 210 records.

One of ordinary skill in the art will recognize that variations on these methods are possible within the spirit of this disclosure.

Partner Sponsorship Offer as Interstitial Product

In another embodiment, a Sponsor may include a partner's Sponsorship Offer as an Interstitial Product when the Sponsor's Sponsorship is used to purchase a Product.

This may be implemented in various ways.

For example, a Consumer who uses a Sponsorship from a local automobile dealership to purchase a Product may receive, as an Interstitial Product, a Sponsorship Offer from a local car wash, tire store, or oil change business that has partnered with the Sponsor of the existing Sponsorship.

In this example, the Consumer would purchase a Product using a Sponsorship 206 record through one of the disclosed methods (i.e., FIG. 9 or FIG. 10). During the construction of the Uniquely Structured Document, including the Product 210 record and associated Interstitial Product 210 record(s), the Interstitial Product 210 record would be a Sponsorship Offer 206 record from a partner of the Sponsor. One of ordinary skill in the art will recognize that variations on these methods are possible within the spirit of this disclosure.

When a partner Sponsorship Offer is accepted, the original Sponsor may add to or extend its existing Sponsorship with the Consumer. For example, a Sponsorship from a soda company may be increased or extended when the Consumer accepts a Sponsorship Offer from the Partner of the soda company (e.g., a snack company). This involves the modification of existing Sponsorship 206 records or creation of new Sponsorship 206 records.

Sponsor Offers Partner Interstitial Product

In another embodiment, a Sponsor may choose to provide the Interstitial Product of a partner, rather than its own Interstitial Product, with the use of a Sponsorship. For example, a Sponsor may have Sponsorships with highly desired Consumers, in which case it may choose to sell to its partners access to those Consumers through the Sponsorships.

One way to implement this embodiment is to include references in the Campaign 204 and/or Sponsorship 206 Attributes to the partner's Interstitial Product 210 record, such that when the processor extrapolates and creates an Interstitial Products Set during the use of the Sponsorship 206 record, the reference to the partner's Interstitial Product 210 record result in the partner's Interstitial Product 210 record being included in the Second IP Set.

For example, a hotel may agree to deliver the advertisement of a nearby restaurant during the use of Sponsorship 206 records that reference one of the hotel's Campaign 204 records, when that use occurs between the hours of noon and 7 pm on Wednesdays or Thursdays. When a Consumer uses one of those Sponsorship 206 records at 5 pm on Wednesday, the processor selects the Interstitial Product 210 record of the restaurant advertisement from the Interstitial Products Set.

Another possible implementation of this embodiment is to reference the partner's Sponsor 202 record and/or Campaign 204 record(s), rather than directly referencing one or more of the partner's Interstitial Product 210 record(s). This implementation may provide more flexibility to the partner in providing Interstitial Product 210 records.

For example, if the hotel Sponsor agrees to deliver an advertisement of the restaurant partner during uses of the hotel's Sponsorship, the hotel's Sponsorship 206 record may reference the partner's Campaign 204 record, which in turn references one or more of the partner's Interstitial Product 210 record(s), rather than directly referencing one or more of the partner's Interstitial Product 210 record(s). This may allow the partner to set and modify Campaign 204 Attributes controlling the selection of Interstitial Product 210 records (e.g., use one Interstitial Product during lunch hours, use a second Interstitial Product during dinner hours) without any action by the Sponsor or modification of the hotel's Sponsor 202, Campaign 204, or Sponsorship 206 records.

An improvement of this embodiment allows the Sponsor to receive payment from the partner in exchange for including the partner's Interstitial Product with the use of the Sponsor's Sponsorship. For example, if the hotel Sponsor agrees to include the restaurant partner's Interstitial Product during the use of the hotel's Sponsorship in exchange for a payment of $0.10 each time the partner's Interstitial Product is included with a use of the hotel's Sponsorship, the processor may make the payment from the restaurant partner to the hotel Sponsor each time the partner's Interstitial Product is included with the use of the Sponsor's Sponsorship. One of ordinary skill in the art will be familiar with such payment processes.

Entity Relationships

In another embodiment, each Campaign 204 record may reference more than one Sponsor 202 record.

For example, if a restaurant chain and a soft drink manufacturer jointly create a Campaign, the Campaign 204 record may reference both Sponsor 202 records. One of ordinary skill in the art will recognize that variations on these methods are possible within the spirit of this disclosure.

In another embodiment, each Sponsorship 206 record may reference more than one Consumer 200 record.

For example, a restaurant may give a Sponsorship to a youth baseball team for use by the individual members of the team, in which case the Sponsorship 206 record may reference one Consumer 200 record for each member of the team. One of ordinary skill in the art will recognize that variations on these methods are possible within the spirit of this disclosure.

### Other Embodiments

While the processes in the specification have been presented in detail, one of ordinary skill in the art could simplify the processes by using ordinary practices. For example, the steps of loading records, matching Attributes, and Ranking and selecting records could be performed in a single step (e.g., using a complex SQL query).

Although the present invention has been described in terms of various embodiments, it is not intended that the invention be limited to these embodiments. Modification within the spirit of the invention will be apparent to one of ordinary skill in the art.

We claim:

1. A computer-implemented method comprising:
receiving a request for first product record;
identifying and retrieving first consumer record for said request;
retrieving at least one consumer sponsorship record referenced by said consumer record;
comparing, on an attribute-by-attribute basis, said product record and each consumer sponsorship record, to produce a set of consumer sponsorship records;
ranking said set of consumer sponsorship records;
selecting at least one consumer sponsorship record from said set of consumer sponsorship records, to produce a preferred set of consumer sponsorship records;
extrapolating a set of interstitial product records from said preferred set of consumer sponsorship records;
constructing from said first product record and said set of interstitial product records, to produce a uniquely structured document;
sending uniquely structured document to requestor.

2. A method according to claim 1, wherein said uniquely structured document is a web page.

3. A method according to claim 1, wherein said uniquely structured document is a data contract.

4. A method according to claim 1, wherein said product is a media file.

5. A method according to claim 1, wherein said comparison step includes first price attribute of said product record and first balance attribute of each consumer sponsorship record.

6. A method according to claim 1, wherein said consumer sponsorship record contains a reference to exactly one consumer record and exactly one sponsor record.

7. A method according to claim 1, further comprising:
receiving context attributes with said request;
wherein said comparing step, compares, on an attribute-by-attribute basis, context attributes and said product record and each consumer sponsorship record, to produce a set of consumer sponsorship records.

8. A non-transitory computer-readable medium including one or more sequences of instructions which, when executed by one or more processors, cause:
receiving a request for first product record;
identifying and retrieving first consumer record for said request;
retrieving at least one consumer sponsorship record referenced by said consumer record;
comparing, on an attribute-by-attribute basis, said product record and each consumer sponsorship record, to produce a set of consumer sponsorship records;
ranking said set of consumer sponsorship records;
selecting at least one consumer sponsorship record from said set of consumer sponsorship records, to produce a preferred set of consumer sponsorship records;
extrapolating a set of interstitial product records from said preferred set of consumer sponsorship records;
constructing from said first product record and said set of interstitial product records, to produce a uniquely structured document;
sending uniquely structured document to requestor.

9. The non-transitory computer-readable medium of claim 8, wherein said uniquely structured document is a web page.

10. The non-transitory computer-readable medium of claim 8, wherein said uniquely structured document is a data contract.

11. The non-transitory computer-readable medium of claim 8, wherein said product is a media file.

12. The non-transitory computer-readable medium of claim 8, wherein said comparison step includes first price attribute of said product record and first balance attribute of each consumer sponsorship record.

13. The non-transitory computer-readable medium of claim 8, wherein said consumer sponsorship record contains a reference to exactly one consumer record and exactly one sponsor record.

14. The non-transitory computer-readable medium of claim 8, wherein the instructions further cause:
receiving context attributes with said request;
wherein said comparing step, compares, on an attribute-by-attribute basis, context attributes and said product record and each consumer sponsorship record, to produce a set of consumer sponsorship records.

15. A system comprising:
one or more processors; and
a non-transitory computer-readable medium including one or more sequences of instructions which, when executed by one or more processors, cause:
receiving a request for first product record;
identifying and retrieving first consumer record for said request;
retrieving at least one consumer sponsorship record referenced by said consumer record;
comparing, on an attribute-by-attribute basis, said product record and each consumer sponsorship record, to produce a set of consumer sponsorship records;
ranking said set of consumer sponsorship records;
selecting at least one consumer sponsorship record from said set of consumer sponsorship records, to produce a preferred set of consumer sponsorship records;
extrapolating a set of interstitial product records from said preferred set of consumer sponsorship records;
constructing from said first product record and said set of interstitial product records, to produce a uniquely structured document;
sending uniquely structured document to requestor.

16. A system according to claim 15, wherein said uniquely structured document is a web page.

17. A system according to claim 15, wherein said uniquely structured document is a data contract.

18. A system according to claim 15, wherein said product is a media file.

19. A system according to claim 15, wherein said comparison step includes first price attribute of said product record and first balance attribute of each consumer sponsorship record.

20. A system according to claim 15, wherein said consumer sponsorship record contains a reference to exactly one consumer record and exactly one sponsor record.

21. A system according to claim 15, further comprising:
receiving context attributes with said request;
wherein said comparing step, compares, on an attribute-by-attribute basis, context attributes and said product record and each consumer sponsorship record, to produce a set of consumer sponsorship records.
